(19) United States
(12) Patent Application Publication
(10) Pub. No.: US 2018/0360066 A1
(43) Pub. Date: Dec. 20, 2018

(54) PROCESS FOR PRODUCING A SEED SUSPENSION

(71) Applicant: AAK AB (publ), Malmö (SE)

(72) Inventor: Morten Daugaard ANDERSEN, Højbjerg (DK)

(73) Assignee: AAK AB (publ), MALMO (SE)

(21) Appl. No.: 16/061,730

(22) PCT Filed: Dec. 12, 2016
(86) PCT No.: PCT/SE2016/051248

§ 371 Date: Jun. 13, 2018

(30) Foreign Application Priority Data
Dec. 21, 2015 (SE) 1551686-7

(51) Int. Cl. A23G 1/00; A23G 1/18; A23G 1/36; A23G 3/02; A23G 3/40

(52) U.S. Cl. CPC A23G 1/0046; A23G 1/18; A23V 2002/00; A23G 3/0226; A23G 3/40; A23G 1/36

(57) ABSTRACT

A method for producing a seed suspension (SSP) is disclosed, the method comprising the steps of: —providing an edible fat (EDF) being melted, —feeding said edible fat (EDF) through a processing zone (PZ), and —performing a crystallization step in said processing zone (PZ) to obtain said seed suspension (SSP) by —subjecting said edible fat (EDF) to a cooling temperature (CT) below 30 degrees Celsius in said processing zone (PZ), and —subjecting said edible fat (EDF) to shear stress in said processing zone (PZ), wherein the edible fat (EDF) comprises SatOSat-triglycerides in an amount of 20 99% by weight. Also, a method of producing a heat stable chocolate, a seed suspension, a confectionary product, and a seed suspension apparatus is disclosed.

### FIELD OF THE INVENTION

The invention relates to the field of confectionary products, such as chocolates and chocolate-like products, and particularly to a method of producing a seed suspension for seeding chocolate. The invention further relates to a seed suspension and a use of a seed suspension for seeding chocolate.

### BACKGROUND

It is known that confectionary products, such as chocolate, produced from a chocolate composition may be susceptible to disadvantageous processes, such as bloom formation. One very used process used to address this problem is to subject the chocolate composition to tempering whereby at least some resistance to bloom formation is obtained. Disadvantages of the tempering process include that it is complicated, time consuming and energy-consuming process, and that the obtained product may not have a desired sufficiently low susceptibility of e.g. bloom formation.

### SUMMARY

The invention relates in a first aspect to a method for producing a seed suspension comprising the steps of:
providing an edible fat being melted,
feeding said edible fat through a processing zone, and
performing a crystallization step in said processing zone to obtain said seed suspension by
   subjecting said edible fat to a cooling temperature below 30 degrees Celsius in said processing zone, and
   subjecting said edible fat to shear stress in said processing zone,

wherein the edible fat comprises SatOSat-triglycerides in an amount of 20-99% by weight, wherein Sat denotes a saturated fatty acid and O denotes oleic acid, and

wherein the edible fat has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride, which is between 0.40 and 0.99, such as between 0.50 and 0.99, such as between 0.70 and 0.99.

The invention relates in a further aspect to a method for producing a seed suspension comprising the steps of:
providing an edible fat being melted,
feeding said edible fat through a processing zone, and
performing a crystallization step in said processing zone to obtain said seed suspension by
   subjecting said edible fat to a cooling temperature below 30 degrees Celsius in said processing zone, and
   subjecting said edible fat to shear stress in said processing zone, and
performing a transformation step in said processing zone by subjecting the seed suspension to a transformation temperature equal to or above 15 degrees Celsius in said processing zone, such as equal to or above 20 degrees Celsius, such as equal to or above 25 degrees Celsius, such as equal to or above 30 degrees Celsius,

wherein the edible fat comprises SatOSat-triglycerides in an amount of 20-99% by weight, wherein Sat denotes a saturated fatty acid and O denotes oleic acid, and wherein the edible fat has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99.

The invention relates in a further aspect to a method for producing a heat stable chocolate, said method comprising the steps of:
providing an edible fat being melted,
feeding said edible fat through a processing zone, and
performing a crystallization step in said processing zone to obtain a seed suspension by
   subjecting said edible fat to a cooling temperature below 30 degrees Celsius in said processing zone, and
   subjecting said edible fat to shear stress in said processing zone,
mixing the seed suspension with a chocolate composition at a temperature above 30 degrees Celsius, such as above 32 degrees Celsius, such as above 34 degrees Celsius, such as above 35 degrees Celsius, to obtain a seeded chocolate composition, and
tempering said chocolate composition before, during and/or after said step of mixing with said seed suspension,
cooling said seeded chocolate composition to obtain said heat stable chocolate,

wherein the edible fat comprises SatOSat-triglycerides in an amount of 20-99% by weight, wherein Sat denotes a saturated fatty acid and O denotes oleic acid, and

wherein the edible fat has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99.

The invention relates in an even further aspect to a seed suspension comprising 20-99% by weight of SatOSat-triglycerides,

wherein said seed suspension has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99, and

wherein the seed suspension exhibits an endotherm melt peak position at about 40 degrees Celsius or higher, such as at about 41 degrees Celsius or higher, such as at about 42 degrees Celsius or higher.

The invention relates in a still further aspect to a confectionary product comprising heat stable chocolate, wherein the heat stable chocolate has a fat phase comprising
20-99% by weight of SatOSat-triglycerides, and
seed crystals,

wherein said seed crystals has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99,

wherein the heat stable chocolate exhibits an endotherm melt peak position at about 35 degrees Celsius or higher, such as at about 36 degrees Celsius or higher, such as at about 37 degrees Celsius or higher, such as at about 38 degrees Celsius or higher.

The invention relates in an even further aspect to a seed suspension apparatus for production of a seed suspension, the seed suspension apparatus being adapted for receiving an edible fat, the seed suspension apparatus comprising
a processing zone adapted to subject shear stress, a cooling temperature and a transformation temperature to said edible fat, and
a control circuit adapted to control
   said cooling temperature to be below 30 degrees Celsius, such as between 5 and 30 degrees Celsius, and
   said transformation temperature to be equal to or above 15 degrees Celsius, such as equal to or above 20 degrees Celsius, such as equal to or above 25 degrees Celsius, such as equal to or above 30 degrees Celsius, such as between 15 and 41 degrees Celsius, such as between 30 and 41 degrees Celsius, such as between 35 and 39 degrees Celsius.

The invention relates in a still even further aspect to a use of a seed suspension obtainable by the method according to any of its embodiments for seeding a chocolate or chocolate-like product.

### THE FIGURES

The invention will be described in the following with reference to the drawings, where

FIGS. 1a, 1b and 1c illustrate a method of producing a seed suspension according to an embodiment of the invention,

FIGS. 2a and 2b illustrate two different applicable processing zones according to embodiments of the invention,

FIG. 3 illustrates an applicable processing zone according to an embodiment of the invention,

FIG. 4 illustrates a cross-sectional view of an applicable processing zone according to an embodiment of the invention,

FIG. 5 illustrates an applicable processing zone according to an embodiment of the invention,

FIG. 6 illustrates a representation of a temperature development of an edible fat according to an embodiment of the invention,

FIGS. 7a and 7b each illustrates the principles of a recirculation process according to an embodiment of the invention,

FIGS. 8a and 8b each illustrates a seed suspension apparatus according to an embodiment of the invention, and

FIG. 9 illustrates a DSC curve for a seed suspension obtained according to an embodiment of the invention.

### DETAILED DESCRIPTION

### Definitions

As used herein, the term “fatty acid” encompasses free fatty acids and fatty acid residues in triglycerides.

As used herein “edible” is something that is suitable for use as food or as part of a food product, such as a dairy or confectionary product. An edible fat is thus suitable for use as fat in food or food product and an edible composition is a composition suitable for use in food or a food product, such as a dairy or confectionary product.

As used herein, “%” or “percentage” all relates to weight percentage i.e. wt. % or wt. % if nothing else is indicated.

As used herein, the singular forms “a”, “an” and “the” include plural referents unless the context clearly dictates otherwise.

As used herein, “at least one” is intended to mean one or more, i.e. 1, 2, 3, 4, 5, 6, 7, 8, 9, 10, etc.

As used herein, “vegetable oil” and “vegetable fat” is used interchangeably, unless otherwise specified.

As used herein, the term “apparatus” refer to a set of materials or equipment designed for a certain use. Consequently, the claimed apparatus may be established as a single device or it may be defined as a number of co-working devices together performing the required process. The process may preferably be defined to be automated with no, little or substantial human interaction along the line.

As used herein, the term “endotherm melt peak position” may refer to the position of a melt peak, which may be the main endotherm melt peak or it may be a smaller melt peak.

As used herein, the term “vegetable” shall be understood as originating from a plant retaining its original chemical structure/composition. Thus, a vegetable fat or vegetable triglycerides are still to be understood as vegetable fat or vegetable triglycerides after fractionation etc. as long as the chemical structure of the fat components or the triglycerides is not altered. When vegetable triglycerides are for example transesterified they are no longer to be understood as a vegetable triglyceride in the present context.

Similarly, the term “non-vegetable” in the context of “non-vegetable triglyceride” or “non-vegetable fat” when used herein is intended to mean obtained from other sources than native vegetable oils or fractions thereof, or obtained after transesterification.

As used herein, “transesterification” should be understood as replacing one or more of the fatty acid moieties of a triglyceride with another fatty acid moiety or exchanging one or more fatty acid moieties from one triglyceride molecule to another. A fatty acid moiety may be understood as a free fatty acid, a fatty acid ester, a fatty acid anhydride, an activated fatty acid and/or the fatty acyl part of a fatty acid. The term ‘transesterification’ as used herein may be used interchangeably with ‘interesterification’. The transesterification process may be an enzymatic transesterification or chemical transesterification. Both chemical transesterification and enzymatic transesterification is described well in the art. Both chemical and enzymatic transesterification may be done by standard procedures.

As used herein, the term “slurry” is a partly melted composition, where at least some seed crystals are present. Thus, a “slurry” may also be understood as a partly melted suspension, partly molten suspension or a paste. Therefore, the term “seed slurry” refers to a slurry comprising at least some seed crystals present in the seed slurry.

As used herein, a “seed suspension” is a suspension made from an edible fat. The seed suspension is usable in the production of confectionary products, such as chocolate and chocolate-like products. The seed suspension comprises seed crystals, and may be suitable for seeding and/or heat stabilizing a chocolate to obtain heat stable chocolate. The seed suspension may be in the form of a slurry, i.e. as a seed slurry.

As used herein, the term “fraction” shall in this regard be understood to be a product remaining after a physical separation of the constituents of a natural source of a fat. This product may subsequently be subjected to a transesterification.

As used herein a “chocolate” is to be understood as chocolate and/or chocolate-like products. Some chocolate comprises cocoa butter, typically in substantial amounts, where some chocolate-like product may be produced low or even without cocoa butter, e.g. by replacing parts or all of the cocoa butter with cocoa butter equivalent, cocoa butter substitute, etc. Also, many chocolate products comprises cocoa powder or cocoa mass, although some chocolate products, such as typical white chocolates, may be produced without cocoa powder, but e.g. drawing its chocolate taste from cocoa butter. Depending on the country and/or region there may be various restrictions on which products may be marketed as chocolate. By a chocolate product is meant a product, which at least is experienced by the consumer as chocolate or as a confectionery product having sensorial attributes common with chocolate, such as e.g. melting profile, taste etc.

As used herein a “heat stable chocolate” is a chocolate which has a relatively high resistance to heat, and heat-related effects, particularly bloom. Said heat stable chocolate will in certain embodiments retain this heat stability, particularly bloom resistance, at temperatures above which such stability is normally lost for conventional chocolate products.

As used herein, the term “bloom resistance” refers to a property of the chocolate to resist bloom formation. Increased or improved bloom resistance in a chocolate in the present context thus implies that the chocolate has a higher resistance towards surface blooming.

As used herein “shear stress” is to be understood as being different from the shear stress arising by simple agitation or stirring. Typically shear stress is associated with providing a relevant substance, here the edible fat, between two surfaces and then moving the two surfaces relative to each other in a direction more or less parallel to the two surfaces. The two surfaces may be provided as a container, such as a cylinder, inside another container, such as another cylinder, the edible fat being provided between the two containers, and the two containers rotating relative to each other. Typically, the relative movement of the two surfaces may be relatively fast, corresponding to a relatively high RPM rotation, and with the two surfaces being relatively close to each other.

As used herein a “scraped surface heat exchanger” is intended to mean an apparatus that is capable of heating and/or cooling a flowable composition and with scraping elements installed that may be capable of scraping off potential any formed layer of crystals or comprising crystals from an inner surface of the scraped surface heat exchanger and potentially with a rotation arrangement installed that may be capable of applying shear stress to the flowable composition.

As used herein a “heat exchanger” is intended to mean an apparatus that is capable of heating and/or cooling a flowable substance and potentially with a rotation arrangement installed that may be capable of applying shear stress to the flowable composition.

As used herein “tempering” is intended to mean a process used on e.g. chocolate mass to obtain the intended crystallization characteristics, particularly for obtaining the desired polymorphic crystallization characteristics. There are many ways of tempering fat. For example, traditional tempering typically uses a tempering machine, which subjects the fat to a series of cooling and heating processes. Alternatively, cold-spraying a melted fat followed by a multi-step thermal treatment process can be used to generate temper fat in a stable polymorphic form. See e.g. U.S. Pat. No. 6,894,178. Employing high shear and subsequently holding the temper fat at a particular temperature for an extended time also results in a highly stable and high melting polymorphic form. Also “seed tempering”, i.e. tempering by addition of seed crystals, e.g. seed crystals comprised in a seed suspension or powder is included. Sometimes, tempering may even include a combination of traditional tempering and seed tempering, e.g. where seed tempering is performed before and/or after traditional tempering, or where there is temporal overlap between traditional tempering and seed tempering, e.g. by adding seed suspension during traditional tempering. Finally, any variation and/or combination of the above-referenced tempering methods can be used to form a stable polymorph of a temper fat.

### Abbreviations

Sat=saturated fatty acid/acyl-group
U=unsaturated fatty acid/acyl-group
St=stearic acid/stearate
A=arachidic acid/arachidate
B=behenic acid/behenate
Lig=lignoceric acid/lignocerate
O=oleic acid/oleate
DSC=Differential Scanning calorimetry

Moreover, the invention relates to a method for producing a seed suspension SSP comprising the steps of:
providing an edible fat EDF being melted,
feeding said edible fat EDF through a processing zone PZ, and
performing a crystallization step in said processing zone PZ to obtain said seed suspension SSP by
   subjecting said edible fat EDF to a cooling temperature CT below 30 degrees Celsius in said processing zone PZ, and
   subjecting said edible fat EDF to shear stress in said processing zone PZ,

wherein the edible fat EDF comprises SatOSat-triglycerides in an amount of 20-99% by weight, wherein Sat denotes a saturated fatty acid and O denotes oleic acid, and

wherein the edible fat EDF has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99.

It is to be understood that crystals are formed in the crystallization step.

It has surprisingly been found that higher-melting crystal forms of vegetable fat or fractions thereof rich in SatOSat-triglycerides with a substantial content of triglycerides having C18-C24 saturated fatty acids in the sn-1 and sn-3 positions of the triglyceride and oleic acid in the sn-2 position of the triglyceride may be rapidly obtained by performing the crystallization step.

In the present context it should be understood that the method steps performed in the crystallization step may not necessarily be carried out in the order indicated. i.e. at a given point in time all steps may be performed simultaneously. In some cases, though, the process may be carried out step-by-step-wise. Subjecting the edible fat to a cooling temperature below 30 degrees Celsius in the processing zone is however at least partly overlapping with subjecting the edible fat to shear stress in the processing zone. Preferably the overlap between the shear stress and the application of the cooling temperature may be substantial or through-out the most of or the entire crystallization step.

It should be understood that for many practical purposes, it may be advantageous to perform the process continuously, i.e. every single step may be performed in a continuous way and/or at a given point in time all steps may be performed in a continuous process.

A significant advantage of embodiments of the invention is that an adjustable amount and type of crystals in the seed suspension may be possible to obtain, by controlling the cooling temperature and shear stress in the processing zone.

Still a further advantage of the invention may be that improved dosing may be obtained by providing a seed product in flowable form as a seed suspension.

Still a further advantage of the invention may be that improved mixability may be obtained by providing a seed product in flowable form as a seed suspension.

The present invention benefits from the fact that the desired seed suspension is obtained through simple measures and that the process may easily be integrated into different already established types of production lines, especially also when the seed suspension is used for seeding chocolate.

The obtained seed suspension may be heated to a higher temperature than conventional seed or seed suspensions based on cocoa butter without losing its seeding properties, and the seed suspension may even have superior properties than conventional seeds based on cocoa butter, since the seed suspension may have a heat stability not obtainable by a seed based on cocoa butter, i.e. the seeding properties are retained at a higher temperature, such as for example above 35 degrees Celsius, such as above 37 degrees Celsius, such as above 38 degrees Celsius, such as above 38 degrees Celsius, such as above 39 degrees Celsius, such as above 40 degrees Celsius. The increased heat stability may be of the seed suspension itself and/or of the seeded chocolate composition SCCM or a heat stable chocolate obtained therefrom, when the seed suspension is used for seeding chocolate. Particularly, the heat stability of a heat stable chocolate or chocolate containing confectionary product may include that the heat stable chocolate or chocolate containing confectionary product may have an improved stability towards blooming, particularly heat induced blooming. This may be due to an obtained seed suspension having a relatively high endotherm melt peak position, such as an endotherm melt peak position at about 40 degrees Celsius or higher and/or due to the chocolate exhibiting an endotherm melt peak position at about 35 degrees Celsius or higher.

Endotherm melt peak positions may for example be identified from a DSC (Differential Scanning calorimetry) melting thermogram obtained by Differential Scanning calorimetry (DSC). This may for example be done by a METTLER TOLEDO DSC 823e with a HUBER TC45 immersion cooling system. For example, seed suspension samples of e.g. 40±4 mg may be hermetically sealed in a 100 microliter aluminum pan, with an empty pan as reference. Then, seed suspension samples may be heated from e.g. 32.0 degrees Celsius to e.g. 50.0 degrees Celsius at a rate of e.g. 3 degrees Celsius per minute to produce a DSC melting thermogram. From this endotherm melt peak positions may be identified.

One advantage of subjecting the edible fat to a cooling temperature below 30 degrees Celsius and shear stress is that crystals may be formed within a short period of time. Subjecting the edible fat simultaneously to a cooling temperature below 30 degrees Celsius and shear stress may provide a synergistic effect, so that the time for generating crystals is shorter than the combined decrease in time for i) separately subjecting the edible fat to a cooling temperature below 30 degrees Celsius without subjecting it simultaneously to shear stress and ii) separately subjecting the edible fat to shear stress without subjecting it simultaneously to cooling.

The seed suspension may comprise a combination of different crystal polymorphic forms and any potential undesired crystal polymorphic forms may subsequently be melted away by heating the seed suspension to a temperature below the temperature where all crystals are melted and above the temperature where the undesired crystal polymorphic forms are melted.

Still one further advantage of the invention may be that the obtained seed suspension may provide for a confectionary product, such as a chocolate-containing product, having improved gloss retention, particularly having improved stability towards heat-induced glossiness loss. This may be due to an obtained seed suspension having a relatively high endotherm melt peak position, such as an endotherm melt peak position at about 40 degrees Celsius or higher and/or due to the chocolate exhibiting an endotherm melt peak position at about 35 degrees Celsius or higher.

According to an advantageous embodiment of the invention, the processing zone PZ comprises a scraped surface heat exchanger SSHE and the shear stress is provided by the scraped surface heat exchanger SSHE.

The purpose of a scraped surface heat exchanger may include controlling the temperature of the edible fat and/or the seed suspension by cooling and/or heating the continuously moving edible fat composition while removing any formed layer of crystals or comprising crystals from a heat transfer surface. Furthermore, a scraped surface heat exchanger may induce shear stress in the edible fat and may increase the turbulence inside a tube and thereby ensure a homogeneous mixture of the edible fat.

The scraped surface heat exchanger may provide both the cooling and the shear stress, and the crystallization step may then take place in at least part of the scraped surface heat exchanger of the processing zone. It is emphasized that in some embodiments, the processing zone comprises further scraped surface heat exchangers. In such embodiments the crystallization step takes place in at least one or part of one of the scraped surface heat exchangers.

According to a further advantageous embodiment of the invention, a first portion of said edible fat EDF is transformed into the seed crystals SC during the crystallization step, and the crystallization step further comprises the step of
mixing the obtained seed crystals SC with a second portion of said edible fat EDF to obtain the seed suspension SSP.

Thus it should be understood that a continuous mixing of the formed seed crystals and the remaining part of the edible fat, i.e. the part of the edible fat not transformed into seed crystals, is performed, such that a relatively homogeneous seed suspension is formed. For example when said seed crystals are formed on a wall having a lowered temperature, the seed crystals may be mixed into the edible fat so as to obtain the relatively homogenous seed suspension. The mixing of the seed crystals SC and the remaining second portion of the edible fat EDF may be facilitated by a mixer, such as a scraped surface heat exchanger.

According to an embodiment of the invention said mixing occurs at a seed mixing temperature SMT above the cooling temperature CT and below or equal to an outset temperature OT of said melted edible fat EDF.

It should be understood that due to the fact that the edible fat is provided as a melted edible fat, and seed crystals are formed, due to the subjection of the cooling temperature, the mean temperature of the edible fat as a whole, including the formed seed crystals, may gradually decrease from the outset temperature towards the cooling temperature. Thus, when the mixing takes place, the seed mixing temperature, i.e. the mean temperature of the mixed seed suspension, will be equal to or below the outset temperature of the melted edible fat and above the cooling temperature.

The seed mixing temperature may for example be above 35 degrees Celsius, such as above 37 degrees Celsius, such as above 38 degrees Celsius, such as above 39 degrees Celsius. The seed mixing temperature may advantageously be between 38 to 40 degrees Celsius.

According to an embodiment of the invention, the cooling temperature CT is between 5 and 30 degrees Celsius, such as between 10 and 30 degrees Celsius, such as between 15 and 30 degrees Celsius, such as between 20 and 30 degrees Celsius, such as between 25 and 30 degrees Celsius, such as between 26 and 29 degrees Celsius.

According to a further embodiment of the invention, the crystallization step is performed for a period of at least 100 seconds, such as at least 150 seconds, such as at least 300 seconds, such as between 150 and 1000 seconds, such as between 150 and 1800 seconds, such as between 300 and 7200 seconds. According to an embodiment, the crystallization step comprises subjecting the edible fat to shear stress and to a cooling temperature during most of or the entire length of the crystallization step.

According to a still further embodiment of the invention, the cooling temperature CT is provided by controlling a wall temperature of said processing zone PZ being in contact with said edible fat EDF during the crystallization step.

It should be understood, in connection with the above embodiment that the edible fat may not necessarily be in contact with the wall during the entire crystallization step, but should be in contact for a result effective period of time to induce sufficient crystallization. Moreover, it should be understood that when the wall may for example be an inner wall of e.g. a container forming at least part of a scraped surface heat exchanger, or it may be a wall of a rotation arrangement within the scraped surface heat exchanger, such as a rotating cylinder, which may be concentric with a container forming at least part of the processing zone. Alternatively, eccentric cylinders may be used in some embodiments.

According to a still further embodiment of the invention, the crystallization step is repeated, such as performed 2, 3, 4, or 5 times, or even more than 5 times.

For example said seed suspension obtained from the output of the processing zone PZ may be recirculated into the crystallization at least one time, such as 2, 3, 4, or 5 times, or even more than 5 times. The crystallization step may also be performed in several scraped surface heat exchangers in series, so for example that the seed suspension output from one scraped surface heat exchanger performing a crystallization step is led into a further scraped surface heat exchanger where a second crystallization step is performed.

According to an advantageous embodiment of the invention, the method further comprises the step of:
performing a transformation step in said processing zone PZ by subjecting the seed suspension SSP to a transformation temperature TT equal to or above 15 degrees Celsius in said processing zone PZ, such as equal to or above 20 degrees Celsius, such as equal to or above 25 degrees Celsius, such as equal to or above 30 degrees Celsius.

It has surprisingly been found that higher-melting crystal forms of vegetable fat or fractions thereof rich in SatOSat-triglycerides and with a substantial content of triglycerides having C18-C24 saturated fatty acids in the sn-1 and sn-3 positions of the triglyceride and oleic acid in the sn-2 position of the triglyceride may be rapidly obtained by performing the crystallization step followed by the transformation step under controlled temperature and optionally shearing conditions.

In embodiments where the method comprises a transformation step, the transformation step may take place in at least part of a scraped surface heat exchanger of the processing zone, or, if the processing zone comprises more than one scraped surface heat exchanger, in at least one or part of one of the scraped surface heat exchangers of the processing zone.

The transformation step comprises at least transformation of lower melting crystals into higher melting seed crystals. Particularly, it may facilitate transformation of crystals of form I, II, III, IV and V into form VI. Transformation occurs at least in the transformation step; however, some transformation may also occur in the crystallization step. Likewise crystallization occurs at least in the crystallization step; however, some crystallization may also occur in the transformation step.

It is possible to transform an adjustable amount of lower melting seed crystals i.e. for example form III, IV and V into higher melting seed crystals i.e. for example form VI seed crystals in the processing zone by controlling and adjusting the transformation temperature.

The crystallization step may in an embodiment be performed in at least a first scraped surface heat exchanger and the transformation step may be performed in at least a second scraped surface heat exchanger.

According to an embodiment of the invention, the transformation step further comprises subjecting said seed suspension to shear stress in said transformation step.

One significant advantage of the above embodiment may be that the transformation may be more efficient, i.e. that a sufficiently high concentration of higher melting seed crystals, such as seed crystals of form V or VI, particularly form VI, may be obtained in a shorter period of time compared to when no shear stress is applied. Shear stress may be provided in a scraped surface heat exchanger and the transformation step may thus be performed in a scraped surface heat exchanger.

The crystallization step and the transformation step may be provided by the same process equipment, e.g. in the same scraped surface heat exchanger, but operated by different operational parameters, e.g. different wall temperatures. The crystallization may also be performed in at least a first scraped surface heat exchanger and the transformation performed in at least a second scraped surface heat exchanger.

In an embodiment of the invention the seed suspension SSP obtained in the crystallization step has a mean post crystallization temperature, and the transformation temperature TT is above said mean post crystallization temperature. An advantage of this embodiment may be that the transformation from lower melting seed crystals to higher melting seed crystals, such as the transformation from form II, III, IV and V into form VI, may proceed at a higher rate, when the temperature is raised compared to the mean post crystallization temperature and/or compared to the cooling temperature, i.e. the transformation temperature TT may be at least 2 degrees Celsius above the cooling temperature CT, such as at least 5 degrees Celsius above, such as at least 10 degrees Celsius above. The transformation temperature should on the other hand not be so high that all the seed crystals melt, and the transformation temperature TT may thus be below an outset temperature OT of the melted edible fat EDF, such as for example at least 2 degrees Celsius below, such as at least 5 degrees Celsius below, such as at least 10 degrees Celsius below.

According to an advantageous embodiment of the invention, the transformation temperature TT is higher than the cooling temperature CT, such as at least 2 degrees Celsius higher, such as at least 4 degrees Celsius higher, such as at least 6 degrees Celsius higher.

According to an advantageous embodiment of the invention, the transformation temperature TT is between 15 and 42 degrees Celsius, such as between 20 and 42 degrees Celsius, such as between 25 and 42 degrees Celsius, such as between 30 and 42 degrees Celsius, such as between 30 and 41 degrees Celsius, such as between 30 and 40 degrees Celsius, such as between 33 and 40 degrees Celsius, such as between 34 and 40 degrees Celsius, such as between 35 and 40 degrees Celsius, such as between 35 and 39 degrees Celsius.

The transformation temperature may be provided as the temperature of a wall of a container, i.e. as a wall temperature, where the wall is in contact with the seed suspension. The container, such as for example a cylinder, may be a scraped surface heat exchanger or be comprised in a scraped surface heat exchanger. The transformation temperature may also be provided as the temperature of a temperature regulating fluid, which is cooling and/or heating the container.

Regardless of how the transformation temperature is provided, important is that the temperature of the whole seed suspension does not exceed the temperature where the highest melting seed crystals melt.

According to a further advantageous embodiment of the invention, the transformation temperature TT is above 35 degrees Celsius.

A transformation temperature above 35 degrees Celsius may provide an attractive combination of rapid transformation of lower melting crystals into desired high melting seed crystals, such as form VI seed crystals, and a viscosity of the seed suspension that enables the seed suspension to be flowable and form part of a continuous process, e.g. in the seeding of chocolate.

According to an embodiment of the invention, the transformation temperature TT is below the temperature where the highest melting crystal polymorphic form, such as form VI, of said seed suspension SSP is melted, such as at least 1 degrees Celsius, such as 2 degrees Celsius, such as 3 degrees Celsius, such as 4 degrees Celsius, such as 5 degrees Celsius, below the endotherm melt peak position of the highest melting crystal polymorphic form.

According to a further embodiment of the invention, the said transformation step is performed for less than 5 hours, such as less than 1 hour, and/or for more than 250 seconds, such as between 250 seconds and 5 hours, such as between 250 seconds and 1 hour, such as between 250 and 1800 seconds.

The time needed in the transformation step to provide the desired amount and type of seed crystals in the seed suspension depends on the transformation temperature and the shear stress applied to the seed suspension. A transformation temperature above 35 degrees Celsius may lead to an acceleration of the desired transformation of lower melting crystals into high melting seed crystals and thus decrease the time in the transformation step to less than 1 hour, such as to less than 15 minutes.

According to a still further embodiment of the invention, the transformation temperature TT is provided by controlling a wall temperature of the processing zone PZ being in contact with said edible fat EDF during the transformation step.

It should be understood, in connection with the above embodiment that said edible fat may not necessarily be in contact with said processing zone wall during the entire transformation, but should be in contact for a result effective period of time to induce sufficient transformation. Moreover, it should be understood that when said processing zone wall, which is a transformation zone wall when the processing zone is or comprises a transformation zone, may for example be an inner wall of e.g. a container forming at least part of the processing zone, or it may be a wall of an rotation arrangement within the processing zone, such as a rotating cylinder, which may be concentric with a container forming at least part of the processing zone. The wall may be a wall of a scraped surface heat exchanger.

According to an even still further embodiment of the invention, the transformation step is repeated, such as performed 2, 3, 4, or 5 times, or even more than 5 times.

For example said transformed seed suspension SSP obtained from said transformation may be recirculated into the transformation at least one time, such as 2, 3, 4, 5 times or even more than 5 times. The transformation step may also be performed in several scraped surface heat exchangers in series, so for example that the seed suspension output from one scraped surface heat exchanger performing a transformation step is led into a further scraped surface heat exchanger where a second transformation step is performed.

According to a further embodiment of the invention, the processing zone PZ comprises or is both a crystallization zone CZ and a transformation zone TZ, if any.

The processing zone may comprise at least one crystallization zone for performing the crystallization step, and, optionally, at least one transformation zone for performing the transformation step, if any. The processing zone may comprise further zones, which may perform other steps than the crystallization and/or transformation step.

Thus it should be understood that the processing zone is or acts as a crystallization zone at least during said crystallization. The processing zone may in many cases also have other functions, such as acting like a transformation zone in embodiments, where a transformation is also employed.

According to an advantageous embodiment of the invention, the mean size of said crystals is less than 20 micrometers, such as less than 15 micrometers, such as less than 10 micrometers, such as less than 5 micrometers. For example X-ray diffraction (XRD) may be used to verify the content of form VI seed crystals.

According to a further advantageous embodiment of the invention, the method is performed continuously.

Both the crystallization and the transformation, if any, may be performed continuously, where a flow of the edible fat EDF is provided.

In an industrial setting it may be a huge advantage that processes are performed in a continuous way, since it may be more time and cost effective.

According to an alternative embodiment, the crystallization is performed continuously, whereas the transformation is performed batch-wise or semi-batch-wise. This may for example be the case when the transformation involves subjecting the seed suspension obtained from the crystallization to a maturing, e.g. by storing the seed suspension in a tank at the transformation temperature, which may e.g. be above 35 degrees Celsius, while stirring and/or mixing the seed suspension in the tank.

The shear stress applied to the edible fat according to an embodiment may be obtained in different ways. Shear stress may for example be obtained, when the edible fat is in contact with a fast rotating object.

According to a further embodiment of the invention, the processing zone PZ comprises a container CON and a rotation arrangement RA, where the rotation arrangement RA is arranged within the container CON and the rotation arrangement RA is rotatable relative to the container CON and said crystallization step and/or transformation step is performed between an inner wall of the container CON and the rotation arrangement RA.

Thus, it should be understood that the processing zone in which the crystallization and/or transformation is performed, e.g. the crystallization zone and/or the transformation zone, comprises or consists of said container and has said rotation arrangement, or may comprise more apparatuses each comprising or consisting of a container with a rotation arrangement. The processing zone may in many embodiments comprise a separate crystallization zone and transformation zone, e.g. provided in separate scraped surface heat exchangers, whereas it in other embodiments is a single zone, e.g. provided in a single scraped surface heat exchanger, possibly operated by different process parameters, e.g. different wall temperatures, when performing crystallization and transformation, if any. It should furthermore be understood that the process equipment forming the crystallization zone and the transformation zone may be identical with respect to the physical and mechanical layout of the equipment, but may also be designed with some difference, for example with respect to the shearing gap i.e. the distance between the container and the rotation arrangement, which may in some cases be less for the crystallization zone.

In an embodiment of the invention the shear stress during the crystallization step and/or transformation step is induced between an inner wall of a container CON and a rotation arrangement RA forming at least part of the processing zone PZ, where the rotation arrangement RA is rotatable relative to the container CON.

The container and the rotation arrangement may form part of a scraped surface heat exchanger and the crystallization step and/or transformation step, if any, may then be performed by the scraped surface heat exchanger between an inner wall of the container being part of a scraped surface heat exchanger and the rotation arrangement being part of a scraped surface heat exchanger.

According to an advantageous embodiment of the invention, the container CON comprises or consists of an outer cylinder OC and said rotation arrangement RA comprises or consists of an inner cylinder IC.

The container may comprise or be an outer cylinder, and the rotation arrangement may comprise or be an inner cylinder, such as a shaft. The rotation arrangement may thus be provided as an inner cylinder and the container may be provided as an outer cylinder. The inner cylinder and/or the outer cylinder may be concentric or they may be eccentric, they may also have an oval cross-section. Thus, according to an embodiment of the invention, the shear stress is obtained between two cylinders. This may for example be provided by a scraped surface heat exchanger, such as a votator.

The edible fat may thus in an embodiment be subjected to a cooling temperature below 30 degrees Celsius provided as a wall temperature of the inner cylinder and/or the outer cylinder.

The inner cylinder and outer cylinder comprised in the processing zone may in an embodiment be a part of a scraped surface heat exchanger and the crystallization step and/or transformation step may thus be performed in at least one scraped surface heat exchanger.

According to a further advantageous embodiment of the invention, the shear stress in said crystallization step and/or said transformation step, if any, is provided between said inner cylinder and said outer cylinder by rotating said inner cylinder relative to said outer cylinder.

According to an even further embodiment of the invention, the inner cylinder is heated, for example by feeding a temperature regulating fluid through a core of said inner cylinder.

The shear stress applied to the edible fat may be provided by rotation, such as rotation of the rotation arrangement relative to the container and such as rotation of a shaft in a heat exchanger, for example a scraped surface heat exchanger.

The shearing rate may in an embodiment be between 1 and 2000 rpm, such as between 10 and 2000 rpm, such as between 100 and 2000 rpm, during the crystallization and/or the transformation, if any. The shearing rate may be provided by the rotation arrangement, which may for example be within a scraped surface heat exchanger.

The distance between the container and the rotation arrangement may influence the magnitude of the shear stress. Most often the shear stress increases when the distance, i.e. the gap the edible fat has to pass, decreases. The distance between the rotation arrangement and the container may be less than 50 mm, such as less than 10 mm, such as between 1 and 5 mm.

The rotation arrangement may be provided with one or more elements, such as blades, adapted for increasing the shear stress.

The elements, such as for example blades, may also be adapted for scraping off seed crystals formed by subjecting the edible fat to the cooling temperature, e.g. provided as a decreased wall temperature of said container and/or said rotation arrangement.

Thus, when for example the cooling temperature is provided as a decreased wall temperature of said container, the elements may be adapted for scraping off seed crystals formed on the walls of the container having the decreased wall temperature.

The rotation arrangement may be provided with one or more elements, such as blades, adapted for inducing a non-unidirectional force on the edible fat and/or seed suspension.

In an embodiment of the invention the crystallization and/or the transformation comprises subjecting said edible fat to extending treatment.

The extending treatment comprises subjecting the edible fat to a non-unidirectional force. Such a non-unidirectional force may for example be provided by using a container and/or a rotation arrangement with an oval or other non-circular cross-section, or by using a rotation arrangement, which is eccentric with the container. Alternatively, or in addition thereto, elements, such as blades, e.g. fixated to the rotation arrangement, may be used. These measures provide a force, e.g. in radial direction, on the edible fact including the seed crystals which varies, whereby a seed crystal at the point of maximum force exhibits a local pressure maximum, and a resulting force in the direction(s) away from this local pressure maximum, which facilitates extending the seed crystal, which in turn facilitate lowering the mean size of the seed crystals.

The non-unidirectional force may have a maximum magnitude in first direction and a minimum magnitude in second direction, where the maximum magnitude is at least twice the minimum magnitude, and where the first direction and the second direction are substantially orthogonal. This may e.g. be at about 150 rpm.

It may be beneficial to ensure that the seed suspension has a specific controlled temperature and/or specific crystal content, and therefore recirculation of the produced seed suspension fat back to a tank with bulk edible fat or back to for example a heat exchanger to re-melt the edible fat outputted from the crystallization and/or transformation step before reiteration of the crystallization step may be favorable. The recirculation and reiteration may be performed until satisfactory seed suspension is expected; the expectation of the seed suspension and properties thereof being based on measurements on the seed suspension and/or on calculations or projections.

According to an advantageous embodiment of the invention, the output of said processing zone PZ may selectively be fed back to an input of said processing zone PZ, for example through one or more heat exchangers, during e.g. initiation of the seed suspension production.

The melted edible fat EDF may have an outset temperature OT of between 40 and 60 degrees Celsius, such as between 45 and 60 degrees Celsius, such as between 50 and 60 degrees Celsius.

In some embodiments, however, the exact temperature of the melted edible fat may not be very critical, as long as it is completely melted and free of any crystals, particularly free of any lower melting crystal forms.

The present inventor has discovered that having a relatively high content of SatOSat-triglycerides in the edible fat may improve the seeding effect of the obtained seed suspension. Thus, according to a further advantageous embodiment of the invention, the edible fat EDF comprises SatOSat-triglycerides in an amount of 30-99% by weight of said edible fat, such as 40-99% by weight of said edible fat, such as 50-99% by weight of said edible fat, such as 60-99% by weight of said edible fat, such as 70-98% by weight of said edible fat, such as 80-99% by weight of said edible fat.

Triglycerides having C18-C24 saturated fatty acids in the sn-1 and sn-3 positions and oleic acid in the sn-2 position” are examples of SatOSat-triglycerides. It should be understood that the saturated fatty acids in the sn-1 and the sn-3 positions may not necessarily be the same, although they may be in some cases. Examples of such triglycerides include StOSt, StOA, StOB, StOLig, AOA, AOB, AOLig, BOB, BOLig, and LigOLig. Triglycerides having C18-C24 saturated fatty acids in the sn-1 and sn-3 positions and oleic acid in the sn-2 position may also comprise a combination of two or more of the triglycerides StOSt, StOA, StOB, StOLig, AOA, AOB, AOLig, BOB, BOLig, and LigOLig.

It may in particular be important to have a relatively high content of high melting SatOSat-triglycerides in the seed suspension in order to obtain high heat stability of the seed suspension and of a resulting confectionary product, such as a chocolate or a chocolate-like product, when the seed suspension is used for seeding chocolate. Thus, according to an embodiment of the invention, the edible fat comprises 20-99% by weight of triglycerides having C18-C24 saturated fatty acids in the sn-1 and sn-3 positions of the triglyceride and oleic acid in the sn-2 position of the triglyceride, such as 40-99% by weight, such as 60-99% by weight, such as 70-95% by weight, such as 80-98% by weight, or such as 50-90% by weight. The edible fat may thus comprise 20-99% by weight of StOSt-triglycerides, such as 40-99% by weight of StOSt-triglycerides, such as 60-99% by weight of StOSt-triglycerides.

According to a further embodiment of the invention the weight-ratio of the edible fat between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

may be between 0.45 and 0.99, such as between 0.50 and 0.99, such as between 0.55 and 0.99, such as between 0.60 and 0.99, such as between 0.65 and 0.99, such as between 0.70 and 0.99.

The edible fat may comprise triglycerides obtained from vegetable sources. Examples of this may be fats obtained from shea, sal, kokum, illipe, mango, mowra, cupuacu, allanblackia, pentadesma or any fraction and/or combination thereof.

According to an advantageous embodiment of the invention, the edible fat EDF comprises StOSt-triglycerides in an amount of 20-99% by weight, such as 40-99% by weight, such as 60-99% by weight, such as 70-99% by weight, such as 70-90% by weight.

When the edible fat comprises StOSt-triglycerides in an amount of 20-99% by weight, such as 40-99% by weight, such as 60-99% by weight, such as 70-99% by weight, the transformation temperature may beneficially be between 15 and 42 degrees Celsius, such as between 20 and 42 degrees Celsius, such as between 25 and 42 degrees Celsius, such as between 30 and 42 degrees Celsius, such as between 30 and 41 degrees Celsius, such as between 30 and 40 degrees Celsius, such as between 33 and 40 degrees Celsius, such as between 34 and 40 degrees Celsius, such as between 35 and 40 degrees Celsius, such as between 35 and 39 degrees Celsius.

According to an embodiment of the invention the edible fat comprises AOA-triglycerides in an amount of 20-99% by weight, such as 40-99% by weight, such as 60-99% by weight, such as 70-99% by weight, such as 70-90% by weight.

When the edible fat comprises AOA-triglycerides in an amount of 20-99% by weight, such as 40-99% by weight, such as 60-99% by weight, such as 70-99% by weight, the transformation temperature may beneficially be between 20 and 47 degrees Celsius, such as between 25 and 47 degrees Celsius, such as between 30 and 47 degrees Celsius, such as between 35 and 47 degrees Celsius, such as between 35 and 46 degrees Celsius, such as between 35 and 45 degrees Celsius, such as between 38 and 45 degrees Celsius, such as between 39 and 45 degrees Celsius, such as between 40 and 45 degrees Celsius, such as between 40 and 44 degrees Celsius.

According to a further embodiment of the invention, the edible fat comprises BOB-triglycerides in an amount of 20-99% by weight, such as 40-99% by weight, such as 60-99% by weight, such as 70-99% by weight, such as 70-90% by weight.

When the edible fat comprises BOB-triglycerides in an amount of 20-99% by weight, such as 40-99% by weight, such as 60-99% by weight, such as 70-99% by weight, the transformation temperature may beneficially be between 25 and 52 degrees Celsius, such as between 30 and 52 degrees Celsius, such as between 35 and 52 degrees Celsius, such as between 40 and 52 degrees Celsius, such as between 40 and 46 degrees Celsius, such as between 40 and 50 degrees Celsius, such as between 43 and 50 degrees Celsius, such as between 44 and 50 degrees Celsius, such as between 45 and 50 degrees Celsius, such as between 45 and 49 degrees Celsius.

According to a still further embodiment of the invention the edible fat comprises LigOLig-triglycerides in an amount of 20-99% by weight, such as 40-99% by weight, such as 60-99% by weight, such as 70-99% by weight, such as 70-90% by weight.

When the edible fat comprises LigOLig-triglycerides in an amount of 20-99% by weight, such as 40-99% by weight, such as 60-99% by weight, such as 70-99% by weight, the transformation temperature may beneficially be between 30 and 57 degrees Celsius, such as between 35 and 57 degrees Celsius, such as between 40 and 57 degrees Celsius, such as between 45 and 57 degrees Celsius, such as between 45 and 51 degrees Celsius, such as between 45 and 55 degrees Celsius, such as between 48 and 55 degrees Celsius, such as between 49 and 55 degrees Celsius, such as between 50 and 55 degrees Celsius, such as between 50 and 54 degrees Celsius.

According to an advantageous embodiment of the invention, the edible fat EDF is or comprises shea fat, such as shea stearin.

For example, shea stearin IV 36 may be used. Alternatively, or in addition thereto, edible fat obtained from other vegetable sources may be used, and/or edible fat obtained from non-vegetable sources may be used. Examples of edible fat obtained from non-vegetable sources includes edible fat obtained by transesterification, such as enzymatic transesterification, e.g. triglycerides obtained from an edible fat and a saturated fatty acid source under the influence of enzymes having 1,3-specific transesterification activity, and edible fat obtained from other enzymatic sources, and edible fat obtained from unicellular organisms such as bacteria, algae or fungi, where fungi comprises yeast and mold. Edible fat obtained as a mixture of edible fat from more than one of the above sources may also be used.

According to an further advantageous embodiment of the invention, the seed suspension SSP exhibits an endotherm melt peak position at about 40 degrees Celsius or higher, such as at about 41 degrees Celsius or higher, such as at about 42 degrees Celsius or higher, such as at about 43 degrees Celsius or higher.

The edible fat treated according to the method of the present invention or embodiments thereof and the resulting seed suspension is particularly useful for seeding purposes in the manufacture of chocolate products. Seeding with the seed suspension comprising high-melting crystals, such as those exhibiting an endotherm melt peak position at about 40 degrees Celsius or higher obtained by the method of the present invention may assist formation of high-melting crystals in the chocolate during tempering or even make possible the omission of a tempering process, whereby the quality of the chocolate may be improved, and its production may be simplified.

An endotherm melt peak position at about 40 degrees Celsius or higher, at about 41 degrees Celsius or higher, or at about 42 degrees Celsius or higher, indicates a large proportion of form VI crystals, when the edible fat comprises StOSt.

According to a still further advantageous embodiment of the invention, the crystallization step and/or said transformation step, if any, is performed so that said seed suspension SSP comprises at least 5% by weight of form VI seed crystals SC, such as at least 10% by weight, such as at least 15% by weight, such as at least 20% by weight. For example X-ray diffraction (XRD) may be used to verify the content of form VI seed crystals.

The seed suspension may be especially suitable for seeding chocolate to produce a heat stable chocolate.

Moreover, the invention relates to a method for producing a heat stable chocolate, said method comprising the steps of:
providing an edible fat EDF being melted,
feeding said edible fat EDF through a processing zone PZ, and
performing a crystallization step in said processing zone PZ to obtain a seed suspension SSP by
   subjecting said edible fat EDF to a cooling temperature CT below 30 degrees Celsius in said processing zone PZ, and
   subjecting said edible fat EDF to shear stress in said processing zone PZ,
mixing the seed suspension SSP with a chocolate composition CCM at a temperature above 30 degrees Celsius, such as above 32 degrees Celsius, such as above 34 degrees Celsius, such as above 35 degrees Celsius, to obtain a seeded chocolate composition SCCM, and
tempering said chocolate composition CCM before, during and/or after said step of mixing with said seed suspension SSP,
cooling said seeded chocolate composition SCCM to obtain said heat stable chocolate,

wherein the edible fat EDF comprises SatOSat-triglycerides in an amount of 20-99% by weight, wherein Sat denotes a saturated fatty acid and O denotes oleic acid, and

wherein the edible fat EDF has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99.

It should be understood that the step of cooling is performed after the step of tempering. Moreover, it should be understood that one or more intermediate steps may be performed after the tempering and/or the mixing with said seed suspension and before the step of cooling. Furthermore, it should be understood that the cooling may be facilitated by active cooling, passive cooling (i.e. cooling to ambient temperature) or a combination thereof.

An important advantage of the seed suspension comprising a relatively large amount of triglycerides having C18-C24 saturated fatty acids in the sn-1 and sn-3 positions and oleic acid in the sn-2 position of the triglyceride compared to conventional seed made from cocoa butter is that the seed suspension can be used for seeding a chocolate at a higher temperature while retaining or increasing heat and/or bloom stability of a traditionally seeded chocolate, and possibly even increased heat and bloom stability may in this way be achieved. Especially a higher resistance towards bloom and heat stability at higher temperatures may be achieved, which is not possible to obtain when seeding with cocoa butter based seeds, which display a lower maximum melting temperature. The fact that a chocolate can be seeded at a higher temperature may also lead to a decreased viscosity of the seeded chocolate composition SCCM and gives the option to enrobe a thinner layer and thus a cheaper end product. It may also give the option of enrobing with a seeded chocolate composition SCCM comprising less fat, which also leads to a cheaper end product.

The possibility of seeding a chocolate at a higher temperature also gives more room for variations in the seeding temperature and therefore simpler process equipment may in some cases be used, when comparing to seeding with cocoa butter based seeds.

The chocolate composition CCM may typically comprise one or more of the following: cocoa butter, cocoa powder, cocoa mass, chocolate liquor, sweetener, such as sugar, flavor, emulsifier, milk fat, and milk powder. The chocolate composition may further comprise cocoa butter improver (CBI).

Particularly, when using emulsifier, the emulsifier may comprise emulsifier not being lecithin, such as sorbitan tri-stearate (STS). The chocolate composition may also comprise a combination of lecithin and emulsifier not being lecithin, such as a combination of lecithin and STS.

Furthermore, in some advantageous embodiments, the chocolate composition may comprise a combination of cocoa butter improver (CBI) and an emulsifier not being lecithin, such as STS.

The present invention may advantageously apply the seeded chocolate composition SCCM for different types of chocolate products, such as chocolate pralines, chocolate shells, chocolate bars, center filled chocolate, etc.

When tempering said chocolate composition CCM before, during and/or after said step of mixing with said seed suspension SSP, the tempering may comprise or consist of traditional tempering, seed tempering, or a combination thereof. When using seed tempering, the seed used for tempering may in some embodiments be or comprise the seed suspension of the present invention, whereas in other embodiments another seed product may be used.

In one embodiment, tempering said chocolate composition CCM includes traditional tempering. The mixing with the seed suspension SSP may be performed before, during and/or after the traditional tempering.

In one embodiment, tempering said chocolate composition CCM includes seed tempering. When the seed tempering is performed by mixing with the seed suspension SSP of the present invention, the tempering is, at least partly, during the mixing with the seed suspension SSP. When the seed tempering is performed by adding a seed product other than the seed suspension of the present invention, the mixing with the seed suspension SSP may be performed before, during and/or after the seed tempering.

In one embodiment, tempering said chocolate composition CCM includes a combination of traditional tempering and seed tempering. When the seed tempering is performed by mixing with the seed suspension SSP of the present invention, the tempering is, at least partly, during the mixing with the seed suspension SSP. When the seed tempering is performed by adding a seed product other than the seed suspension of the present invention, the mixing with the seed suspension SSP may be performed before, during and/or after the seed tempering.

According to an advantageous embodiment, the method further comprises the step of
mixing said seed suspension SSP with a chocolate composition CCM to obtain a seeded chocolate composition SCCM,
tempering said chocolate composition CCM before, during and/or after said step of mixing with said seed suspension SSP.

Chocolate may be produced in many different ways, but most often it involves the overall steps of processing, mixing of ingredients, conching, tempering and molding. The mixing of the seed suspension with a chocolate composition may easily be combined with the standard steps in the production of chocolate.

Surprisingly improved resistance to heat and bloom instability may also be obtained when the seed suspension is used for seeding a traditionally tempered chocolate product. The seed suspension may be added before, during and/or after traditional tempering of the chocolate composition.

Effective mixing of the seed suspension with the chocolate composition may be facilitated by means of controlling the temperature during mixing such that the seed suspension is partly melted, to melt undesired crystal polymorphic form such as, while retaining desired crystal polymorphic forms such as form VI and/or form V.

One advantage of using a seed suspension is that it is pumpable and thus easier to handle and may be used in a continuous flow. Also, the seed suspension is easier to mix with other ingredients such as chocolate compositions.

Furthermore, the amount of seed suspension added to the chocolate composition may be may be easier to control in an industrial setting, which may employ continuous flow processes.

According to an embodiment of the invention, the temperature of mixing the chocolate composition with the seed suspension is above 35 degrees, such as above 37 degrees Celsius, such as between 38 degrees Celsius to 40 degrees Celsius.

Moreover, the invention relates to a seed suspension SSP comprising 20-99% by weight of SatOSat-triglycerides,

wherein said seed suspension SSP has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99, and

wherein the seed suspension exhibits an endotherm melt peak position at about 40 degrees Celsius or higher, such as at about 41 degrees Celsius or higher, such as ab about 42 degrees Celsius or higher.

According to a further embodiment of the invention said seed suspension SSP comprises seed crystals SC having a mean seed crystal size of less than 20 micrometer, such as less than 15 micrometer, such as less than 10 micrometer. The mean seed crystal size may be measured via suitable techniques known in the art, including e.g. microscope observations.

According to an embodiment of the invention, the seed suspension SSP is obtainable by the method for producing the seed suspension according to any of its embodiments.

Moreover, the invention relates to a confectionary product comprising heat stable chocolate, wherein the heat stable chocolate has a fat phase comprising
20-99% by weight of SatOSat-triglycerides, and
seed crystals,

wherein said seed crystals has a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.50 and 0.99, such as between 0.70 and 0.99, and

wherein the heat stable chocolate exhibits an endotherm melt peak position at about 35 degrees Celsius or higher, such as at about 36 degrees Celsius or higher, such as at about 37 degrees Celsius or higher, such as at about 38 degrees Celsius or higher.

The confectionary product may comprise components further to heat stable chocolate, or may consist of heat stable chocolate. When the confectionary product comprises components other than heat stable chocolate, such components may typically include one or more of a filling, a coating, partially or fully covered edible objects, such as e.g. nuts or biscuits. Fillings may for example include liquid, solid or semi-solid fillings; such as for example include caramel, nougat, liquor, marzipan, etc. Moreover, the heat stable chocolate may in some embodiments be used as a coating or partial coating to cover all or some of a confectionary. The skilled person will appreciate that many different options exist for confectionary products, the important thing is that the confectionary product must comprise heat stable chocolate according to the invention, as described above.

The heat stable chocolate included in the confectionary product may for example comprise the ingredients listed for the chocolate composition, as long as it also comprises seed crystals according to the invention.

According to an embodiment of the invention, the seed crystals of the heat stable chocolate have a mean seed crystal size of less than 20 micrometer, such as less than 15 micrometer, such as less than 10 micrometer. The mean seed crystal size may be measured via suitable techniques known in the art, including e.g. microscope observations.

According to a further embodiment of the invention, the heat stable chocolate comprises 40-99% by weight of SatOSat-triglycerides, such as 60-99% by weight of SatOSat-triglycerides.

In a still further embodiment of the invention, some or all of the SatOSat-triglycerides in the fat phase of the heat stable chocolate may come from the seed crystals.

In an even further embodiment of the invention, the seed crystals comprise 20-99% by weight of SatOSat-triglycerides.

The heat stable chocolate may have a weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99, such as between 0.45 and 0.99, such as between 0.50 and 0.99, such as between 0.55 and 0.99, such as between 0.60 and 0.99, such as between 0.65 and 0.99, such as between 0.70 and 0.99.

The seed crystals of the heat stable chocolate may comprises 20-99% by weight of triglycerides having C18-C24 saturated fatty acids in the sn-1 and sn-3 positions of the triglyceride and oleic acid in the sn-2 position of the triglyceride, such as 60-99% by weight, such as 70-95% by weight, such as 80-98% by weight, or such as 50-90% by weight.

According to a further embodiment of the invention, the seed crystals are added in the form of the seed suspension SSP obtained by the method according to any of its embodiments or in the form of the seed suspension SSP according to any of its embodiments.

Moreover, the invention relates to a seed suspension apparatus SSA for production of a seed suspension SSP, the seed suspension apparatus SSA being adapted for receiving an edible fat EDF, the seed suspension apparatus SSA comprising
a processing zone PZ adapted to subject a shear stress, a cooling temperature CT and a transformation temperature TT to said edible fat EDF, and
a control circuit CC adapted to control
   said cooling temperature CT to be below 30 degrees Celsius, such as between 5 and 30 degrees Celsius, and
   said transformation temperature to be equal to or above 15 degrees Celsius, such as equal to or above 20 degrees Celsius, such as equal to or above 25 degrees Celsius, such as equal to or above 30 degrees Celsius, such as between 15 and 41 degrees Celsius, such as between 30 and 41 degrees Celsius, such as between 35 and 39 degrees Celsius.

According to an advantageous embodiment of the invention, the seed suspension apparatus SSA is adapted to operate in accordance with the method according to any of its embodiments.

Moreover, the invention relates to a use of a seed suspension SSP obtained by a method according to any of its embodiments for seeding a chocolate or chocolate-like product.

The seed suspension may be added to a stream of chocolate composition, where the chocolate composition may have a temperature between 25 and 38 degrees Celsius when the seed suspension is added. The seed suspension may also be added to a stream of chocolate composition to form a seeded chocolate composition SCCM, where the chocolate composition is subjected to tempering before, during and/or after the addition of the seed suspension. The seed suspension may beneficially be added to a stream of a tempered chocolate composition to form a seeded, tempered chocolate composition.

According to an embodiment of the invention, the production of chocolate in which the seed suspension may be used is production without any tempering steps. One significant advantage of this embodiment may be that the production time and cost may be reduced while producing a comparable or even better chocolate product.

According to an embodiment of the invention, the production of chocolate in which the seed suspension may be used is production with at least one tempering step. One advantage of this embodiment may be that when using traditional tempering, the tempering may be shortened. Thus, the production time and cost may be reduced while producing a comparable or even better chocolate product. The heat stability and/or resistance towards bloom formation of the chocolate may also be improved compared to a seeded chocolate without tempering or a tempered chocolate without seeding.

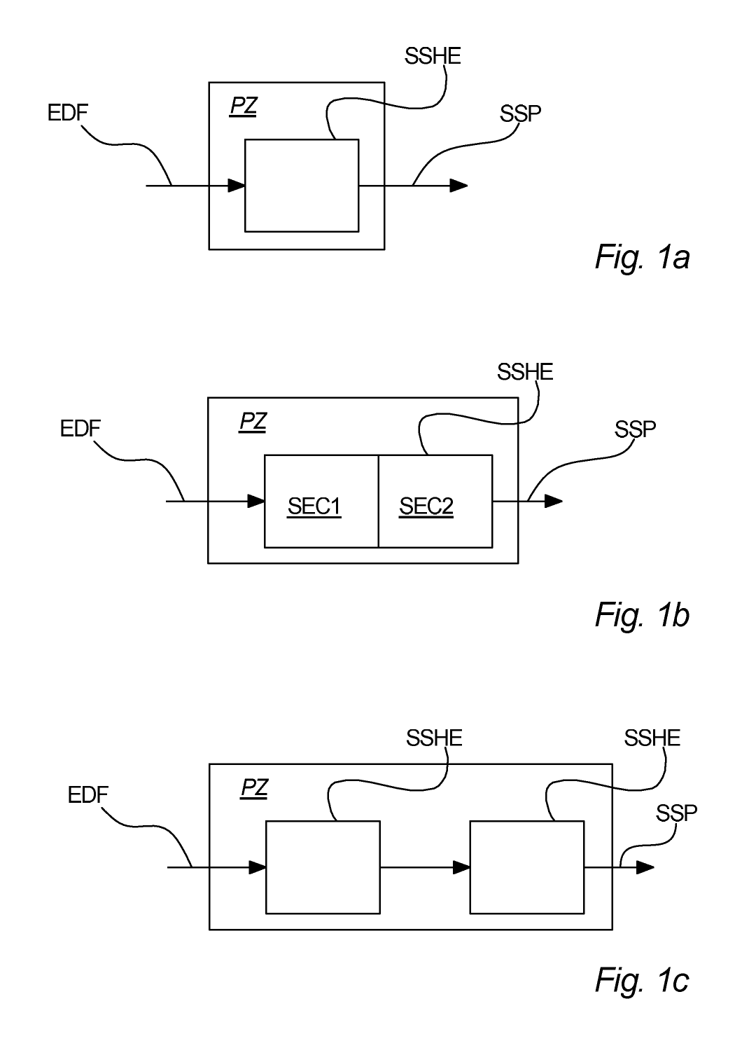

Referring to FIG. 1a a method for producing a seed suspension is illustrated. The method comprises the following steps. First, an edible fat EDF being melted is provided. Then, the edible fat EDF is fed through a processing zone PZ. A crystallization step is performed in the processing zone PZ. To obtain the seed suspension SSP, the crystallization step comprises the steps of subjecting the edible fat EDF to a cooling temperature below 30 degrees Celsius in the processing zone PZ, and subjecting the edible fat EDF to shear stress in the processing zone PZ.

The edible fat EDF used in this method comprises SatOSat-triglycerides in an amount of 20-99% by weight, wherein Sat denotes a saturated fatty acid and O denotes oleic acid. Moreover, the edible fat EDF comprises both triglycerides having C18-C24 saturated fatty acids in the sn-1 and sn-3 positions and oleic acid in the sn-2 position of the triglyceride and also triglycerides having C16-C24 saturated fatty acids in the sn-1 and sn-3 positions and oleic acid in the sn-2 position of the triglyceride. In the edible fat EDF, the weight-ratio between
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

which is between 0.40 and 0.99.

In the processing zone, at least a crystallization step is performed to obtain the seed suspension SSP. The processing zone may comprise or be a crystallization zone CZ. When the processing zone PZ comprises a crystallization zone CZ, the crystallization step is performed at least partly in the crystallization zone CZ.

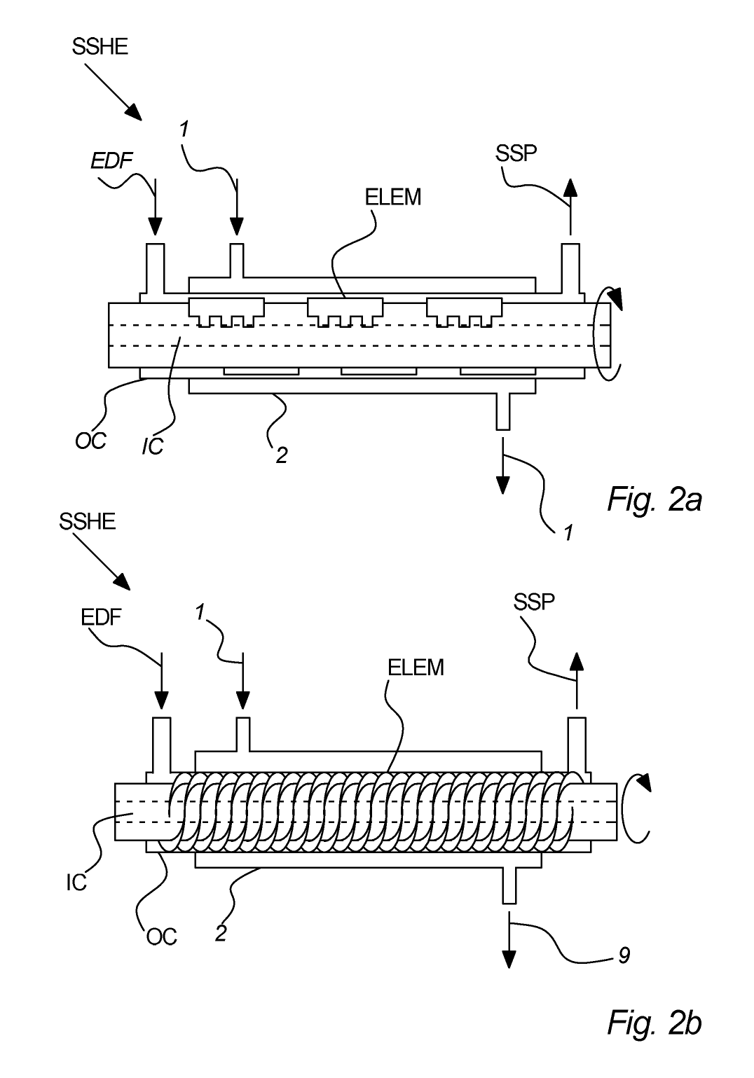

The function of the crystallization step in the processing zone PZ comprises at least to produce crystals. The basic operations of the crystallization step in the processing zone PZ comprises subjecting the edible fat to a cooling temperature below 30 degrees Celsius and shear stress to grow crystals. Depending on parameters such as temperature, time and shear, the crystals may be low melting crystals forms, high melting crystal forms or a combination thereof. The processing zone PZ may comprise different types of crystallization equipment known in the art, such as the two exemplary embodiments of scraped surface heat exchangers SSHE shown and explained below in FIGS. 2a and 2b. A scraped surface heat exchanger SSHE may be regarded as the processing zone or a part of the processing zone PZ, where crystals of edible fat EDF are produced.

Several different types of heat exchangers may be applied within the scope of the invention in the crystallization step. Applicable types of scraped-surface heat exchangers SSHE include but are not limited to:
Rotating, tubular scraped-surface heat exchangers. In this type, the shaft is placed parallel to the tube axis, not necessarily coincident, and spins at various frequencies, typically from a few dozen rpm to more than 1000 rpm. The number of blades may typically vary between 1 and 4 and may take advantage of centrifugal forces to scrape the inner surface of the tube. Examples are the Waukesha Cherry-Burrell Votator II, Alfa Laval Contherm and Terlet Terlotherm.
Reciprocating, tubular scraped-surface heat exchangers. In this type, the shaft is concentric to the tube and moves longitudinally without rotating. The frequency typically spans between 10 and 60 strokes per minute. The blades may vary in number and shape, including e.g. baffle-like arrangements to perforated disk configurations. An example is the HRS Heat Exchangers Unicus.
Rotating, plate tubular scraped-surface heat exchangers. In this type, the blades wipe the external surface of circular plates arranged in series inside a shell. The temperature regulation fluid runs inside the plates. The frequency is typically about several dozen rpm. An example is the HRS Spiratube T-Sensation.

As mentioned, other types of scraped-surface heat exchangers may be used within the scope of the invention as long as the heat exchanger is able to produce the desired crystals required for producing a seed suspension and/or crystals for the subsequent transformation into higher melting seed crystal polymorphic forms.

Moreover, other types of heat exchanger may also be used provided that they can operate with a sufficient shear-rate and provided that they can deliver a temperature below 30 degrees Celsius.

FIG. 1b illustrates a method of producing a seed suspension according to an embodiment of the invention. The method may be performed in the same way as illustrated for FIG. 1a, with the following adjustments and/or additions. The processing zone PZ may comprise both a crystallization step and a transformation step. The processing zone may also for example comprise two or more crystallization steps performed with identical or different parameters such as for example temperature and/or shear rate. As illustrated in FIG. 1b, the crystallization step may take part in a first section SEC1 of a scraped surface heat exchanger and the transformation step or the second crystallization step in a second part SEC2 of the same scraped surface heat exchanger and thus the crystallization step and the transformation step or two crystallization steps may directly follow each other, e.g. with a negligible space in between. This may in practice mean that the seed suspension SSP from the crystallization step is led for example directly into the transformation step. This may for example be possible if the crystallization step and transformation step are within the same scraped surface heat exchanger S SHE. In the crystallization step of the processing zone PZ the edible fat EDF is subjected to a cooling temperature CT below 30 degrees Celsius and in the transformation step of the processing zone the seed suspension SSP is subjected to a transformation temperature TT equal to or above 15 degrees Celsius, such as equal to or above 20 degrees Celsius, such as equal to or above 25 degrees Celsius, such as equal to or above 30 degrees Celsius.

FIG. 1c illustrates a method of producing a seed suspension according to an embodiment of the invention. The method may be performed in the same way as illustrated for FIG. 1a, with the following adjustments and/or additions. The processing zone PZ may in addition to a crystallization step also comprise a transformation step. As illustrated in FIG. 1c, the crystallization step may be performed in one scraped surface heat exchanger SSHE and the transformation step may be performed in a second and/or another scraped surface heat exchanger SSHE. The transformation step may follow subsequent to the crystallization step, but other process steps may also occur in between.

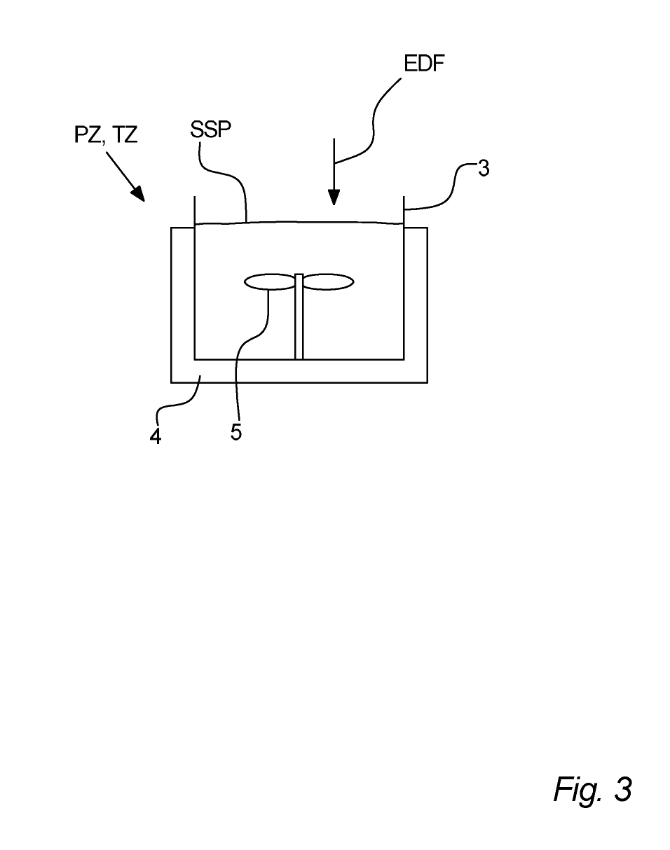

The crystallization step may however not be limited to be performed in one scraped surface heat exchanger SSHE, as well as the transformation step is not limited to be performed in one scraped surface heat exchanger SSHE. Several scraped surface heat exchangers SSHE, such as 2, 3, 4 or more, may perform the crystallization step and several, such as 2, 3, 4, or more, scraped surface heat exchangers SSHE may perform the transformation step. The processing zone PZ may thus comprise one or several, such as 2, 3, 4 or more, scraped surface heat exchangers SSHE. The transformation step may be performed in one or more scraped surface heat exchangers SSHE, but it may also be performed in other equipment suitable for performing the transformation step, such as for example the batch variant illustrated in FIG. 3.

FIGS. 2a and 2b illustrate two possible implementations of a scraped surface heat exchanger SSHE according to an embodiment of the invention.

The scraped surface heat exchanger SSHE provided in FIG. 2a or FIG. 2b may be used and applied in the system of FIG. 1a-c in order to create crystals and/or seed crystals SC in the inputted edible fat EDF.

The purpose of a scraped surface heat exchanger SSHE is to heat and/or cool a continuously moving edible fat composition by removing any formed layer of crystals or comprising crystals from the inner wall of an outer cylinder, such as for example a heat transfer surface. Furthermore, a scraped surface heat exchanger SSHE may increase the turbulence inside an outer cylinder, such as for example a tube, and thereby ensure a homogeneous mixture of the edible fat EDF.

As an alternative applying the cooling temperature on the inner wall of the outer cylinder, the cooling temperature may be applied on an outer wall of an inner cylinder. Then, the formed layer of crystals or comprising crystals would form on the outer wall of the inner cylinder, i.e. the scrapers or scraping elements then needs to be adjusted to remove this formed layer.

FIG. 2a illustrates a scraped surface heat exchanger SSHE using a set of elements ELEM here illustrated as scrapers or scraping elements.

The scraped surface heat exchanger SSHE may comprise an outer cylinder OC, such as for example a heat transfer tube, wherein the floating edible fat EDF is processed. The outer cylinder OC, such as for example a heat transfer tube, is enclosed in a temperature regulating tube 2 that further encloses a temperature regulating fluid 1. The temperature regulating fluid 1 could comprise water, brine, ammonia, glycol or similar fluids suited for heating and/or cooling.

Inside the outer cylinder OC, such as for example a heat transfer tube, an inner cylinder IC, such as for example a shaft comprising scraping elements ELEM is rotating. The scraping elements ELEM are positioned in such a way that they scrape the inner wall of the outer cylinder OC when the inner cylinder IC is rotating.

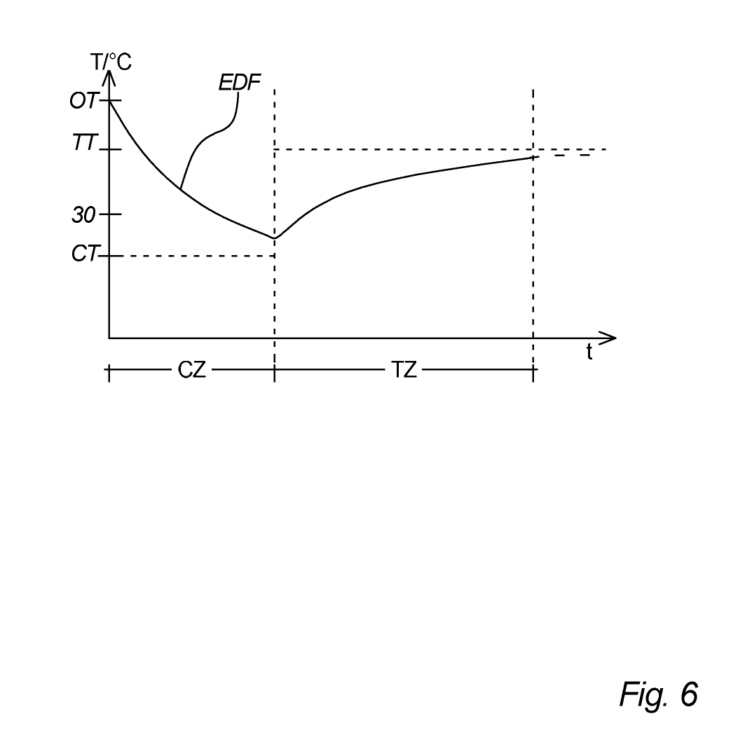

In one embodiment, the scraped surface heat exchanger SSHE is used to generate crystals in an edible fat EDF by feeding the scraped surface heat exchanger SSHE with an edible fat EDF. The edible fat EDF is feed into the outer cylinder OC. Inside the outer cylinder OC, the edible fat EDF that comes in contact with the inner wall of the outer cylinder OC, gets scraped off by the rotating scraping elements ELEM and further transported through the outer cylinder OC. The edible fat EDF that is transported inside the outer cylinder OC will be subjected to a specific temperature, a cooling temperature CT by the temperature regulating fluid 1 that surrounds the outer cylinder OC. Examples of the temperatures are illustrated on FIG. 6. It should be noted that the temperature of the edible fat EDF is not necessarily constant during the process flow. Typically the temperature would fall between the input of the scraped surface heat exchanger SSHE and the output of the scraped surface heat exchanger SSHE or a position within the scraped surface heat exchanger SSHE.

Alternative to the above, the cooling may be applied on the inner cylinder IC, while heating is applied on the outer cylinder.

The scraped surface heat exchanger SSHE illustrated on FIG. 2a may also be used in a transformation step. There, a transformation temperature TT equal to or above 15 degrees Celsius, such as equal to or above 20 degrees Celsius, such as equal to or above 25 degrees Celsius, such as equal to or above 30 degrees Celsius, is used instead of the above described cooling temperature CT.

Thus, the scraped surface heat exchanger SSHE illustrated on FIG. 2a may be used either as a crystallization zone CZ or a part thereof, or as a transformation zone TZ or a part thereof.

In another embodiment the scraped surface heat exchanger SSHE comprises other types of elements ELEM, namely a spiral scraper, as illustrated in FIG. 2b. The spiral scraper ELEM is adapted to move the edible fat EDF along between the inner cylinder IC and the outer cylinder OC, while continuously scraping the inner wall of the outer cylinder, thereby performing the same functionality as the set of elements ELEM illustrated in FIG. 2a.

In some embodiments the scraped surface heat exchanger SSHE illustrated on FIG. 2a or 2b can be divided into several sections along the scraped surface heat exchanger SSHE, enabling the edible fat EDF to be subjected to a crystallization step in the first section SEC1 and a transformation step in the second section SEC2 while moving though the scraped surface heat exchanger SSHE. Thus, enabling both the crystallization step and transformation step to take place within the same scraped surface heat exchanger SSHE. This is also illustrated in FIG. 1b.

It should be noticed that a kneading unit, such as a pin rotor machine, may in some embodiments be implemented e.g. subsequent to the scraped surface heat exchangers S SHE.

FIG. 3 illustrates a possible implementation of a transformation step according to an embodiment of the invention.

The transformation step of a processing zone PZ provided in FIG. 3 may be used and applied in the system of FIG. 1b or FIG. 1c in order to transform lower melting crystal polymorphic forms into higher melting crystal polymorphic forms in the inputted seed suspension SSP. This may typically be a transformation of form I, II, III and IV into form V and/or form VI. The transformation step may thus enrich the seed suspension SSP in seed crystals SC and may typically predominantly comprise form V and form VI crystal polymorphic forms. The crystals being transformed in the transformation step may be created in the preceding crystallization step or they may also be created during the transformation step itself.

The seed suspension SSP received from a previous crystallization step is poured into a large container or tank 3. The seed suspension SSP may also be referred to as a slurry reflecting or illustrating the nature of the edible fat, namely that the edible fat EDF has obtained an increased viscosity compared to the completely melted edible fat due to the presence of crystals in the edible fat EDF. The container or tank 3 is temperature controlled by a surrounding jacket 4. Other temperature control means may of course be applied within the scope of the invention as long as at least a fraction of the seed suspension is subjected to a transformation temperature TT equal to or above 15 degrees Celsius, such as equal to or above 20 degrees Celsius, such as equal to or above 25 degrees Celsius, such as equal to or above 30 degrees Celsius, through the process.

The seed suspension SSP contained in the container or tank 3 may be agitated by means of a stirrer 5 during at least a part of the time during which the edible fat EDF is undergoing the desired transformation by subjecting the seed suspension SSP to a transformation temperature TT above or equal to 15 degrees Celsius, such as equal to or above 20 degrees Celsius, such as equal to or above 25 degrees Celsius, such as equal to or above 30 degrees Celsius. The temperature must be carefully controlled not to exceed the temperature at which the highest melting crystal polymorphic forms are completely melted. The seed suspension SSP may also simply be stored in the transformation step at a temperature equal to or above 15 degrees Celsius, such as equal to or above 20 degrees Celsius, such as equal to or above 25 degrees Celsius, such as equal to or above 30 degrees Celsius, without stirring.

The stirrer 5 may of course be supplemented by further stirrers or modified stirrers. The stirring may occur partly or during the entire duration of the transformation step.

The transformation step of the processing zone PZ may be an integrated part of a continuous process, but it may also be working in batch mode.

The obtained seed suspension SSP from the transformation step is typically flowable and may be transferred to a subsequent process step.

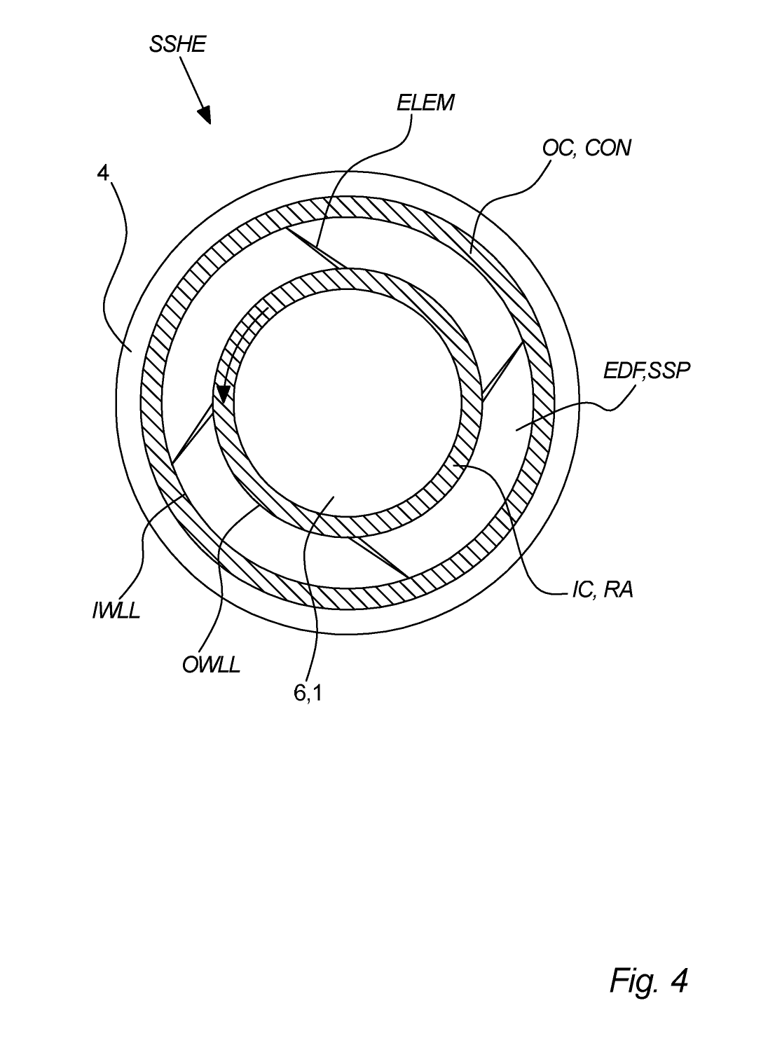

FIG. 4 illustrates a cross-sectional view of a scraped surface heat exchanger SSHE according to an embodiment of the invention. The scraped surface heat exchanger SSHE on FIG. 4 may be of the same type illustrated on FIG. 2a. The scraped surface heat exchanger SSHE comprises a container CON, here shown as an outer cylinder OC, and a rotating arrangement RA, here shown as an inner cylinder IC; the inner cylinder being located inside the outer cylinder OC. The cylinders are concentric, as illustrated on FIG. 4. In some alternative embodiments the cylinders may be eccentric. The edible fat is located between the inner cylinder IC and the outer cylinder OC. The inner IC and/or outer cylinder OC is capable of rotating with respect to the other cylinder and this relative rotation may give rise to shear stress in the edible fat EDF.

The scraped surface heat exchanger SSHE of this embodiment comprises elements ELEM here illustrated as blades or scrapers that are capable of scraping solidified edible fat of the inner wall IWLL of the outer OC and/or the outer wall OWLL of the inner cylinder IC. The elements ELEM may be designed to decrease the passage of the seed suspension which may in itself introduce shear stress and/or add to the shear stress provided by the scraped surface heat exchanger SSHE. The blades may also be designed to decrease the size of the fat crystals.

In an alternative embodiment, the blades or scraper may be attached to the outer cylinder, i.e. arranged to scrape the surface of the inner cylinder. This may particularly be interesting when the cooling temperature is provided by the inner cylinder.

Both the inner cylinder IC and/or outer cylinder OC may be cooled and/or heated. The cooling may be provided in many different ways, such as for example by a surrounding jacket 4 comprising for example water surrounding the outer cylinder OC. The temperature of the inner cylinder IC may also be regulated, for example by leading a temperature regulating fluid 1, which temperature can be regulated, through a core 6 of an inner cylinder IC. This may e.g. prevent crystals from forming on the inner cylinder. When the cooling temperature is provided by the inner cylinder, the outer cylinder may be heated. The cylinders may be insulated, which may lead to a more precise temperature regulation of the cylinder walls.

The smaller the distance between the inner and the outer cylinder the more the shear stress may increase. Crystallization may take place simply by cooling the edible fat EDF, but shear stress provided by a scraped surface heat exchanger SSHE may speed up the crystallization process significantly. Shear stress may also increase the amount of desired form VI seed crystals, which may not otherwise be obtainable by subjecting the edible fat to cooling itself. Thus, if the shear is to be increased, the distance may be lowered; whereas if the shear is to be decreased, the distance may be increased. It should be noted, that increasing the shear may typically speed up the crystal transformation, at least up to a certain point.

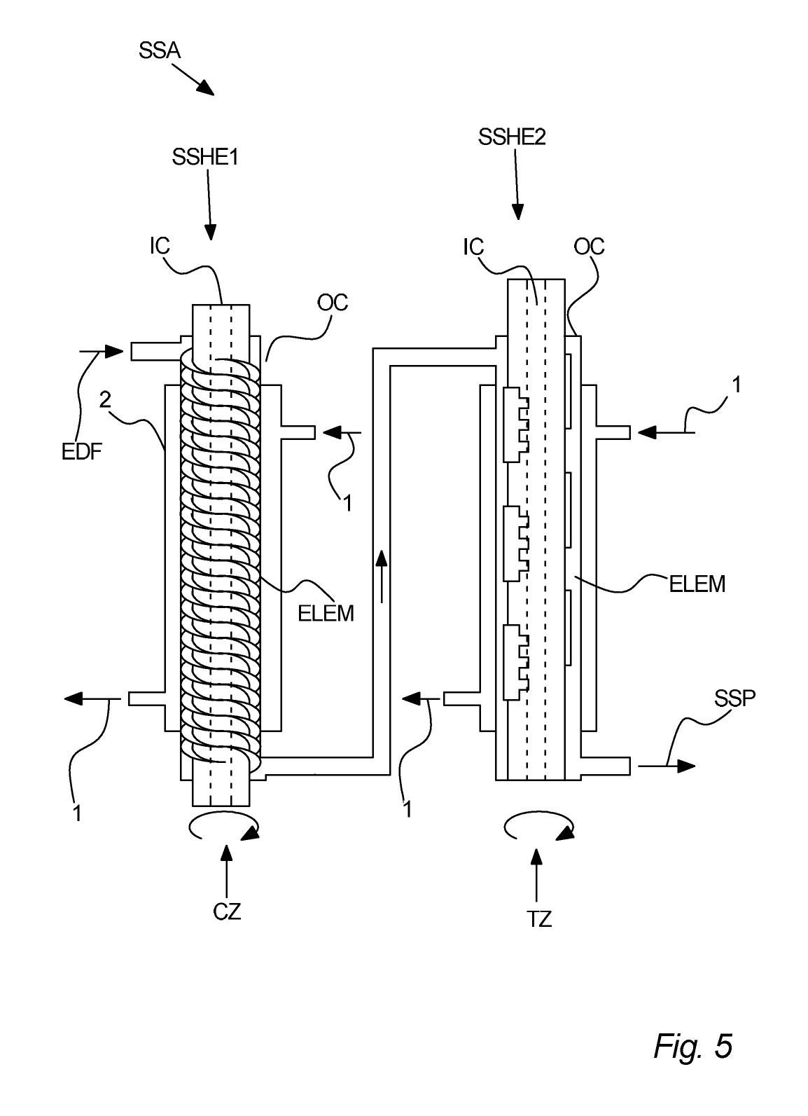

FIG. 5 illustrates a seed suspension apparatus SSA comprising an arrangement of the scraped surface heat exchangers SSHE1, SSHE2 according to an embodiment of the invention. The scraped surface heat exchangers SSHE1, SSHE2 may be arranged in series as illustrated in FIG. 5. In some other embodiments, two scraped surface heat exchangers may be arranged in parallel, e.g. when only a crystallization zone or crystallization step is utilized, or when the scraped surface heat exchangers are operated similar to what is illustrated on FIG. 1b. Returning to FIG. 5, a first scraped surface heat exchanger SSHE1 comprising scrapers similar to the scraped surface heat exchanger of FIG. 2a is illustrated to the left and a second scraped surface heat exchanger SSHE2 comprising a spiral scraper similar to the scraped surface heat exchanger SSHE of FIG. 2b is illustrated to the right. In alternative embodiments, the scraped surface heat exchangers may comprise the same type of elements ELEM. The scraped surface heat exchangers SSHE illustrated in FIG. 5 adopt a vertical position, which may be the standard operational mode, but they may also operate in a horizontal mode or placed at an angle to the surface on which they are placed. In FIG. 5, the first scraped surface heat exchanger SSHE1 forms a crystallization zone CZ, while the second scraped surface heat exchanger SSHE2 forms a transformation zone TZ. Alternatively, the crystallization step may take place in one or both scraped surface heat exchangers, and it may also take placed in many more scraped surface heat exchangers than illustrated in FIG. 5, such as 3, 4, 5 or more scraped surface heat exchangers SSHE. The crystallization step may also be performed in one scraped surface heat exchanger SSHE and the transformation step may be performed in a subsequent scraped surface heat exchanger SSHE. In principle the crystallization step and the transformation step may be performed in the same scraped surface heat exchanger SSHE if the temperature of a first part of the scraped surface heat exchanger SSHE is below the cooling temperature CT of 30 degrees Celsius and the temperature of another part of the scraped surface heat exchanger SSHE is regulated as to subject the edible fat EDF to a transformation temperature TT of equal to or above 15 degrees Celsius, such as equal to or above 20 degrees Celsius, such as equal to or above 25 degrees Celsius, such as equal to or above 30 degrees Celsius. In some embodiments the distance between the output of the first scraped surface heat exchanger SSHE1 and the input of the second scraped surface heat exchanger SSHE2 may be less than illustrated on FIG. 5.

FIG. 6 illustrates a process temperature curve of the edible fat EDF at a time t during the process performed in the processing system illustrated in FIG. 1b-c according to an embodiment of the invention. The illustrated temperature represents an average temperature for a given cross-section of the system, the longitudinal position of the cross-section corresponding to the shown time t.

It should be noted that the temperature curve of FIG. 6 is shown for illustrative purposes only and does not necessarily illustrate a real-life temperature development through-out the system of FIG. 1b-c. The temperature may vary, but the principles of a relatively high outset temperature OT, which is decreased in or during at least part of the crystallization step of the crystallization zone CZ to a cooling temperature CT below 30 degrees Celsius. The temperature is then raised to a transformation temperature TT equal to or above 15 degrees Celsius, such as equal to or above 20 degrees Celsius, such as equal to or above 25 degrees Celsius, such as equal to or above 30 degrees Celsius, before or during at least part of the transformation step in the transformation zone TZ.

In embodiments where only a crystallization step is employed, the temperature curve within the crystallization zone CZ alone may illustrate the temperature variations.

It should also be noted the temperature curve of FIG. 6 are in no way restricted to reflect the specific time or place on or in which the processed edible fat EDF is heated or cooled. The illustrated temperature may rather refer to an illustration of an average temperature of the relevant steps or a temperature effective of providing the desired properties of the seed suspension SSP.

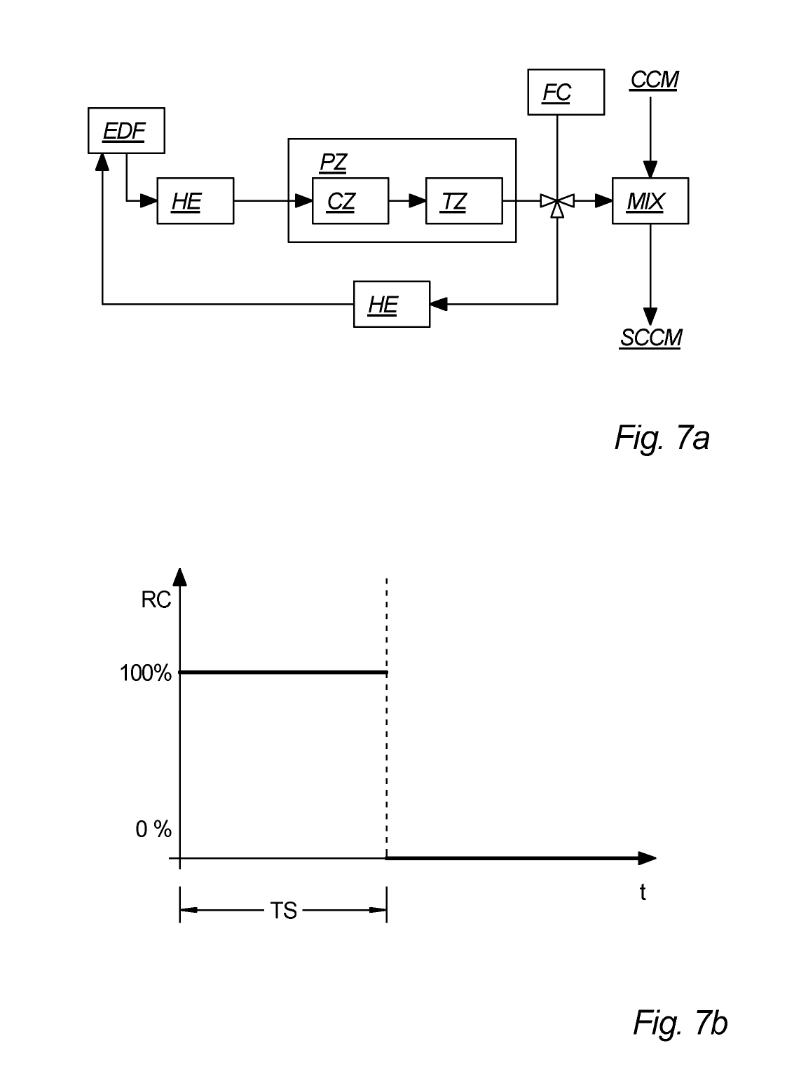

FIG. 7a illustrates a method of producing a seed suspension SSP according to an embodiment of the invention. This embodiment includes the option of recirculating the seed suspension SSP. Edible fat EDF is drawn from a feed tank and fed to the processing zone PZ. It may be beneficial to ensure that the edible fat EDF has a specific controlled temperature and is completely melted such that no crystals exist prior to entering the crystallization step. This may be achieved for example by implementing a heat exchanger HE, such as a plate heat exchanger in the process line before the processing zone PZ, in which the crystallization step of the crystallization zone CZ occurs. Thereby, the edible fat may be delivered to the processing zone PZ at a temperature above the storage temperature of the feed tank, thus conserving energy by not keeping the feed tank at the higher temperature. The crystallization step, and an optional transformation step of a transformation zone TZ, may be performed according to the aforementioned embodiments, including the embodiments of FIG. 1b or FIG. 1c to produce a seed suspension SSP. The seed suspension SSP may then be used as a seed for seeding chocolate to obtain a heat stable chocolate by mixing MIX the seed suspension with a chocolate composition CCM. It may however be advantageous to re-melt the seed suspension SSP obtained from the processing zone PZ by feeding it through a heat exchanger HE. The melted edible fat EDF is recirculated to a feed tank containing the bulk edible fat EDF or to a heat exchanger HE placed before the crystallization step. Whether recirculation may be necessary and/or beneficial may be determined by a feed-back control unit FC. The feed-back control unit FC may for example be a person measuring the temperature and/or content of crystals as determined by a DSC melt peak thermogram at the output of the crystallization zone CZ and/or transformation zone TZ and when this is not optimal, the seed suspension SSP may be recirculated back into a heat exchanger and/or the tank containing edible fat EDF. This may also be a completely automatized process carried out by apparatus.

When the seed suspension SSP has satisfactory properties, the recirculation may be terminated. The seed suspension SSP is then mixed with a chocolate composition CCM at a temperature above 35 degrees Celsius to obtain a seeded chocolate composition SCCM. The chocolate composition CCM is tempered before, during and/or after said step of mixing with said seed suspension SSP.

FIG. 7b illustrates an embodiment of the invention where recirculation of the seed suspension SSP is utilized. For example, the embodiment of FIG. 7b may be understood in the context of the embodiment illustrated on FIG. 7a. At first, edible fat EDF is processed into a seed suspension SSP, but the obtained seed suspension SSP is all recirculated and re-melted by the heat exchanger HE, as explained in connection with FIG. 7a. When the processing equipment, including e.g. heat exchangers, such as scraped surface heat exchanger, and the relevant parameters are properly adjusted and the result is satisfactory, e.g. due to a satisfactory endotherm melt peak position or DSC melting thermogram, the recirculation may be terminated and the seed suspension SSP may be fed onwards, e.g. into a process of making confectionary products, such as chocolate or chocolate-like products. As explained with FIG. 7b, the switching between recirculation or not may be controlled by a feed-back control unit FC. As illustrated on FIG. 7b, the seed suspension is either recirculated or fed to the mixing MIX with the chocolate composition CCM to obtain a seeded chocolate composition SCCM.

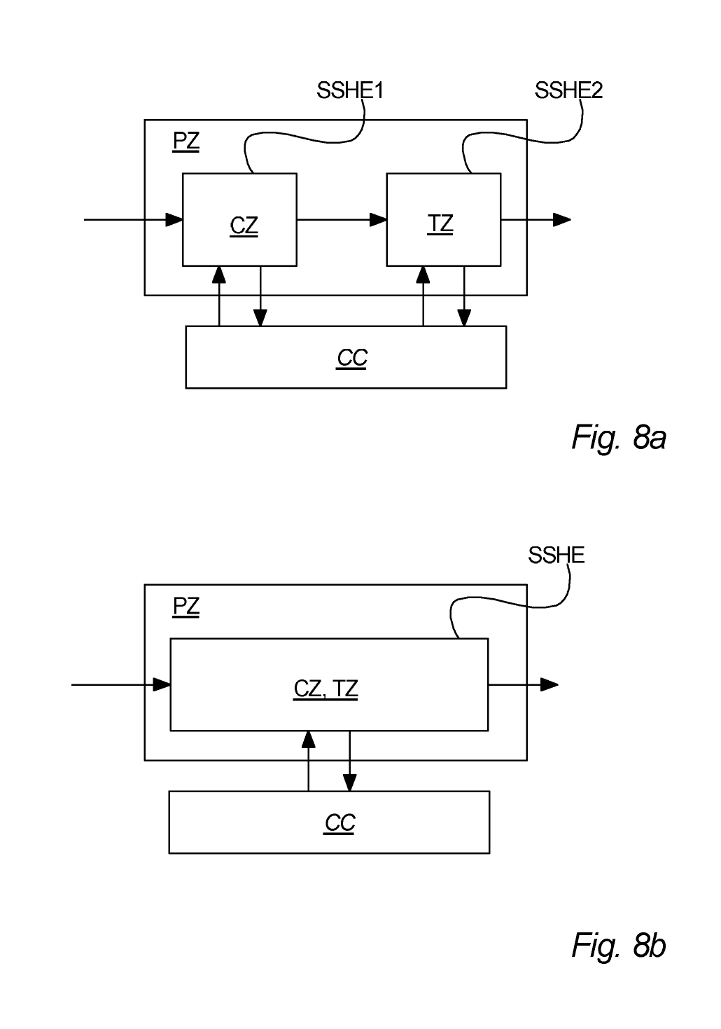

FIG. 8a illustrates a seed suspension apparatus SSA according to an embodiment of the invention. The seed suspension apparatus SSA in this embodiment comprises a processing zone PZ and a control circuit CC. The processing zone PZ is adapted to apply shear stress, a cooling temperature CT and a transformation temperature TT to the edible fat EDF. This may for example be by means of at least one heat exchanger HE, such as at least one scraped surface heat exchanger SSHE.

The regulation technique employed to regulate the cooling and/or transformation temperatures may advantageously be by the use of or include the use of a PID controller.

A PID controller is a control loop feedback system that calculates the difference between a desired set point from an input parameter and a measured set point of a process e.g. a temperature. It may in particular be advantageous to use a PID controller when the process requires fast and precise adjustments. A PID controller is separated into three terms: proportional, integral and derivative. The proportional term yields a value that is proportional to the current error. This error can be adjusted by the proportional gain constant (Kp). If this gain becomes too high it will result the in the system becoming unstable. If the gain is too small the system cannot adjust appropriately accordingly to the error. The integral term yields a value that is proportional to the error and the duration of the error. The integrated term gives an accumulated offset that may not have been corrected previously. This term accelerates the movement towards the set point. The derivative term yields a value that is determined by the gradient of the error. This term is a predictive term that helps stabilizing the system.

Simpler alternatives to PID control may include e.g. control by use of one or two of the proportional, integral and derivative parts of PID control.

The processing zone may comprise at least a crystallization zone CZ and optionally a transformation zone TZ. The crystallization zone CZ comprises at least a crystallization step and the transformation zone TZ comprises at least a transformation step. The crystallization step may be performed in one scraped surface heat exchanger SSHE and the transformation step in another scraped surface heat exchanger SSHE as illustrated in FIG. 8a. Temperature sensors may be positioned for example at the inner surface shell of each zone or in a compartment comprising a temperature regulating fluid 1 to monitor the temperature applied to the edible fat EDF or temperature sensors in the edible fat EDF to monitor the temperature of the edible fat EDF. A control circuit CC is connected to the sensors. The control circuit CC receives inputs from the sensors and adjusts the temperature accordingly e.g. by means of the PID control. The control circuit may then control the cooling temperature CT of one craped surface heat exchanger SSHE and the transformation temperature In another embodiment each zone has its own control circuit CC, i.e. each scraped surface heat exchanger SSHE may be individually controlled by a control circuit CC.

As illustrated in FIG. 8b, the control circuit CC may control the temperature of a scraped surface heat exchanger SSHE, in such a way that the scraped surface heat exchanger SSHE may comprise both a crystallization zone CZ and a transformation zone TZ, and hence perform both a crystallization step and a transformation step

The control circuit CC may regulate the cooling CT and/or transformation temperature TT for example by regulating the temperature of a temperature regulating fluid 1 by using a control loop feedback mechanism such as a PID controller algorithm. However in another embodiment a different method such as state space models or predictive feedback control could be used. The advantage of using PID controller for controlling the temperature is based on the algorithms simplicity and robustness compared to others. The PID controller algorithm may ensure that any changes in the temperature of the temperature regulating fluid 1 is perform such that the temperature will not exceed a given threshold i.e. does not overshoot that can cause all the crystals within the edible fat EDF/seed suspension SSP to melt, thus ensuring that the seed functionality of the seed suspension is retained.

In this embodiment the controller can make rapid and precise adjustments to the temperature of the temperature regulating fluid 1 in case of changes in flow through each zone, without overheating the edible fat EDF/seed suspension SSP.

In alternative embodiments, only a single temperature sensor may be employed.

The illustrated seed suspension apparatus SSA may be controlled according to different regulation techniques and of course by means of different sensor arrangements. The sensors may vary in type, number, and positioning. The sensors may also measure the temperature of the seed suspension by having contact with the sensors, if a contact sensor is applied.

### EXAMPLES

The invention is now illustrated by way of examples.

Analysis of Seed Suspension Samples

In example 1, seed suspension samples were analyzed by Differential Scanning calorimetry (DSC). This was done by a METTLER TOLEDO DSC 823e with a HUBER TC45 immersion cooling system. 40±4 mg of seed suspension samples were hermetically sealed in a 100 microliter aluminum pan, with an empty pan as reference. Seed suspension samples were heated from 32.0 degrees Celsius to 50.0 degrees Celsius at a rate of 3 degrees Celsius per minute to produce a DSC melting thermogram. From this endotherm melt peak positions are identified.

Shea Stearin IV 36

TABLE 1
Triglyceride composition of Shea stearin IV 36

| Fat composition | Shea stearin IV 36 |
|---|---|
| SatOSat (% w/w) | 80.3 |
| StOSt (% w/w) | 67.4 |
| Ratio StOSt/SatOSat (% w/w) | 0.84 |
| Sat2OSat2* (% w/w) | 71.4 |
| Ratio Sat2OSat2/SatOSat (% w/w) | 0.89 |
| Ratio Sat2OSat2/(C16-C24)O(C16-C24) (% w/w) | 0.89 |

Sat2OSat2* = triglycerides having C18-C24 saturated fatty acids in the sn-1 and sn-3 positions and oleic acid in the sn-2 position.
“Ratio StOSt/SatOSat” denotes the weight-ratio between StOSt triglycerides and SatOSat triglycerides, whereas “Ratio Sat2OSat2/SatOSat” denotes the weight-ratio between Sat2OSat2 triglycerides and SatOSat triglycerides.

### Example 1

Two samples S-1 and S-2 of Shea Stearin IV 36 obtained from a feed tank were subjected to a processing zone PZ according to FIG. 1c, where the crystallization zone was provided in a first Scraped Surface Heat Exchanger (SSHE1) and samples S-3 and S-4, respectively, obtained from the outlet of the first Scraped Surface Heat Exchanger (SSHE1). The obtained samples S-3 and S-4 from the crystallization zone output were subjected to a transformation zone TZ provided in a second Scraped Surface Heat Exchanger (SSHE2) as illustrated in FIG. 1c, to obtain samples S-5 and S-6, respectively, of seed suspension. The processing zone PZ of this examples thus comprises two Scraped Surface Heat Exchangers (SSHE1, SSHE2) coupled in series. The parameters and settings of the Scraped Surface Heat Exchangers and measured seed suspension temperatures are listed in table 2.

TABLE 2
Settings of the Scraped Surface Heat Exchangers.

| | Input sample | |
|---|---|---|
| | S-1 | S-2 |
| Sample reference SSHE1 | S-3 | S-4 |
| Sample reference SSHE2 | S-5 | S-6 |
| Feed tank temperature (degrees Celsius) | 40.0 | 40.0 |
| Product flow (kilogram per hour) | 6.2 | 6.2 |
| Retention time in SSHE1 (min) | 23 | 23 |
| SSHE1 rotational speed (Rotations per minute) | 161 | 161 |
| Temperature of surrounding jacket of SSHE1 | 26.0 | 26.0 |
| (degrees Celsius) | | |
| Seed suspension temperature at outlet from SSHE1 | 31.4 | 32.4 |
| (degrees Celsius) | | |
| Retention time in SSHE2 (min) | 23 | 23 |
| SSHE2 rotational speed (Rotations per minute) | 161 | 161 |
| Temperature of surrounding jacket of SSHE2 | 32.0 | 30.0 |
| (degrees Celsius) | | |
| Seed suspension temperature at outlet from SSHE2 | 34.7 | 34.7 |
| (degrees Celsius) | | |

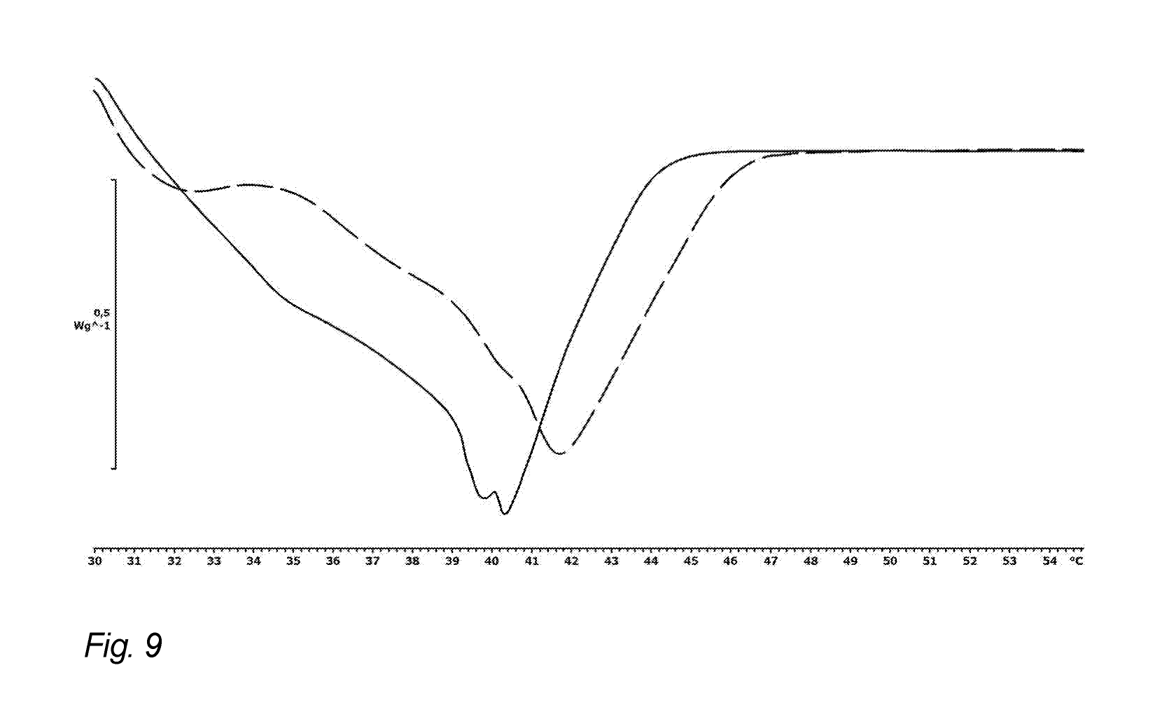

A test sample was extracted from the crystallization zone output for each of samples S-3, S-4, and from the transformation zone output for each of the seed suspension samples S-5 and S-6 and analyzed according to “Analysis of seed suspension samples” to produce a DSC melting thermogram. The produced DSC melting thermogram corresponding to samples S-3 and S-5 are illustrated as the solid and dashed line in FIG. 9, respectively. Endotherm melt peak positions are identified as in table 3. Here, the x-axis refers to temperature and the y-axis is given in Watt per gram. Endotherm melt peak positions of S-3 and S-5 as well as of S-4 and S-6 are identified as in table 3.

TABLE 3
Endotherm melt peak positions of obtained samples.

Sample reference

| | S-3 | S-4 |
|---|---|---|
| Endotherm melt peak position (degrees | 40.3 | 41.1 |
| Celsius) | | |

Sample reference

| | S-5 | S-6 |
|---|---|---|
| Endotherm melt peak position (degrees | 41.7 | 41.9 |
| Celsius) | | |

As seen from table 3, an increase in endotherm melt peak positions is observed for samples after the outlet of the second Scraped Surface Heat Exchanger (SSHE2) as compared to the endotherm melt peak position at the outlet after the first Scraped Surface Heat Exchanger (SSHE1).

### Example 2

### Milk Chocolate and Dark Chocolates of Reference and Inventive Compositions.

Tables 4 below show the recipes and the fat compositions for milk chocolates and dark chocolates, respectively.

Milk chocolates I and dark chocolates I were each hand tempered on marble table and used to produce 20 gram chocolate bars.

The molten milk chocolates II and dark chocolates II were each stirred at 35 degrees Celsius in an open bowl. The seed suspension sample S-5 from the outlet of the second Scraped Surface Heat Exchanger (SSHE2) in a slurry like state at 34.7 degrees Celsius with a mean particle size of approximately 10-20 micrometer, was added to the chocolates and mixed for 15 minutes. Thereafter, the chocolates were poured into 20 gram chocolate bar molds.

The molds were subsequently cooled in a three zones cooling tunnel for a total of 30 minutes, first 10 minutes at a temperature of 15 degrees Celsius, followed by 10 minutes at a temperature at 12 degrees Celsius, followed by 10 minutes at a temperature of 15 degrees Celsius.

Weight percentages in table 4 below refer to the total recipe and to the fat composition of the chocolate, respectively.

TABLE 4
Recipes and fat compositions for milk and dark chocolates

| | Milk | | Dark | |
|---|---|---|---|---|
| Recipe | Chocolate I | Milk | Chocolate I | Dark |
| (in % w/w) | (reference) | Chocolate II | (reference) | Chocolate II |
| Seed (sample S-5) | — | 1 | — | 1 |
| Shea Stearin IV 36 | — | 4 | — | 4 |
| Cocoa butter | 18 | 13 | 10 | 5 |
| Cocoa mass | 16 | 16 | 39 | 39 |
| Sugar | 42.6 | 42 | 50.6 | 50 |
| Whole milk powder | 18 | 18 | — | — |
| Skim milk powder | 5 | 5 | — | — |
| Lecithin | 0.4 | 0.4 | 0.4 | 0.4 |
| STS | — | 0.6 | — | 0.6 |

Fat composition

| | | | | |
|---|---|---|---|---|
| Content (% w/w) | | | | |
| Seed suspension | — | 3 | — | 3 |
| Shea Stearin IV 36 | — | 12 | — | 12 |
| Cocoa butter | 85 | 70 | 100 | 85 |
| Milk fat | 15 | 15 | — | — |
| Total fat content | 30.9 | 30.9 | 31.5 | 31.5 |

Composition of the fat phase of the chocolate (excluding milk fat, if any,
and seed)

| | | | | |
|---|---|---|---|---|
| STS (% w/w) | — | 2.0 | — | 2.0 |
| SatOSat (% w/w) | 82.1 | 81.8 | 82.1 | 81.9 |
| StOSt (% w/w) | 27.1 | 33.0 | 27.1 | 32.1 |
| Ratio StOSt/SatOSat | 0.33 | 0.40 | 0.33 | 0.39 |
| Sat2OSat2* (% w/w) | 28.9 | 35.1 | 28.9 | 34.2 |
| Ratio Sat2OSat2*/SatOSat | 0.35 | 0.43 | 0.35 | 0.42 |

Sat2OSat2* = triglycerides having C18-C24 saturated fatty acids in the sn-1 and sn-3 positions and oleic acid in the sn-2 position.

The total fat content in the recipe is calculated as the sum of shea stearin IV 36, CB, fat content of the cocoa mass (approx. 56% w/w of cocoa butter in cocoa mass), milk fat and the fat content of skim milk powder.

Emulsifier not being lecithin (here STS), when added, is thus present in an amount of approx. 2% by weight of the total fat content.

The seed suspension (sample S-5) was manufactured as described in example 1.

### Example 3

### Bloom Resistance of Chocolate Bars of Milk- and Dark Chocolate

After 7 days storage at 20 degrees Celsius chocolate bars from example 2 were placed in a programmable temperature cabinet and subjected to a heat treatment at a high temperature for 10 hours followed by a low temperature for 14 hours. This heat treatment was performed once. The high temperatures were 35 or 37 degrees Celsius+/−0.5 degrees Celsius and the low temperatures were 20, 23, 24 or 25 degrees Celsius+/−0.5 degrees Celsius.

The chocolate bars were examined for bloom after one heat treatment.

Table 5 below illustrates the test result in respect of bloom effect observed for milk and dark chocolate bars of example 2, table 4, after one heat treatment under different high- and low temperature settings.

TABLE 5
Bloom on milk and dark chocolate samples after one heat treatment

| | | | Dark | |
|---|---|---|---|---|
| | Milk | Milk | Chocolate | Dark |
| | Chocolate I | Chocolate | I | Chocolate |
| Heat treatment | (reference) | II | (reference) | II |
| 37-25 degrees Celsius | − | + | − | + |
| 37-24 degrees Celsius | − | + | − | + |
| 37-23 degrees Celsius | − | + | − | + |
| 37-20 degrees Celsius | − | + | − | + |
| 35-25 degrees Celsius | − | ++ | − | ++ |
| 35-24 degrees Celsius | − | ++ | − | ++ |
| 35-23 degrees Celsius | − | ++ | − | ++ |

“++” denotes a glossy and un-bloomed chocolate surface
“+” denotes a dull but un-bloomed chocolate surface
“−” denotes a bloomed chocolate surface

The data in Table 5 show that Milk Chocolates II exhibit at least an un-bloomed chocolate surface after heat treatment under all tested conditions, whereas the reference Milk Chocolate I exhibit a bloomed chocolate surface after one heat treatment regardless of the tested temperatures.

The data in Table 5 show that Dark Chocolates II exhibit at least an un-bloomed chocolate surface after one heat treatment under all tested temperature conditions, whereas the reference Dark Chocolate I a bloomed chocolate surface after one heat treatment regardless of the tested temperatures.

Clearly, Milk Chocolate II and Dark chocolate II display enhanced bloom resistance when compared to both Milk Chocolate I and Dark Chocolate I.

Furthermore, the data of table 5 illustrates that chocolate products having improved glossiness stability may be obtained.

### LIST OF FIGURE REFERENCES

CC. Control circuit
CCM. Chocolate composition
CON. Container
CT. Cooling temperature
CZ. Crystallization zone
EDF. Edible fat
ELEM. Elements
FC. Feed-back control
HE. Heat exchanger
IC. Inner cylinder
IWLL. Inner wall of outer cylinder
MIX. Mixing
OC. Outer cylinder
OT. Outset temperature
OWLL. Outer wall of inner cylinder
PZ. Processing zone
SCCM. Seeded chocolate composition
SSA. Seed suspension apparatus
SSHE. Scraped surface heat exchanger
SSHEi. i'th scraped surface heat exchanger
SECi. i'th section
SSP. Seed suspension
TT. Transformation temperature
TZ. Transformation zone
1. Temperature regulating fluid
2. Temperature regulating tube
3. Container
4. Surrounding jacket
5. Stirrer
6. Core

1-38. (canceled)

39. A method for producing a seed suspension comprising:
performing a crystallization step on an edible fat in a processing zone to obtain the seed suspension by:
subjecting the edible fat to a cooling temperature below 30 degrees Celsius in the processing zone; and
subjecting the edible fat to shear stress in the processing zone;
wherein the edible fat comprises SatOSat-triglycerides in an amount of 20-99% by weight, wherein Sat denotes a saturated fatty acid and O denotes oleic acid, and
wherein the edible fat has a weight-ratio between that of
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,
of between 0.40 and 0.99.

40. The method of claim 39, wherein the processing zone comprises a scraped surface heat exchanger and the shear stress is provided by the scraped surface heat exchanger.

41. The method of claim 39, wherein a first portion of the edible fat is transformed into seed crystals during the crystallization step and the crystallization step further comprises mixing the seed crystals with a second portion of the edible fat to obtain the seed suspension.

42. The method of claim 39, wherein the cooling temperature is between 5 and 30 degrees Celsius.

43. The method of claim 39, wherein the cooling temperature is provided by controlling a wall temperature of the processing zone in contact with the edible fat during the crystallization step.

44. The method of claim 39, wherein the crystallization step is repeated.

45. The method of claim 39, further comprising:
performing a transformation step in the processing zone by subjecting the seed suspension to a transformation temperature equal to or above 15 degrees Celsius.

46. The method of claim 45, wherein the transformation step further comprises subjecting the seed suspension to shear stress.

47. The method of claim 45, wherein the transformation temperature is higher than the cooling temperature.

48. The method of claim 45, wherein the transformation temperature is between 15 and 42 degrees Celsius.

49. The method of claim 45, wherein the transformation temperature is below the highest melting temperature of a crystal polymorphic form of the seed suspension.

50. The method of claim 45, wherein the transformation step is performed for less than 5 hours.

51. The method of claim 45, wherein the transformation temperature is provided by controlling a wall temperature of the processing zone in contact with the edible fat during the transformation step.

52. The method of claim 45, wherein the transformation step is repeated.

53. The method of claim 39, wherein the processing zone comprises a crystallization zone and a transformation zone.

54. The method of claim 39, wherein the method is performed continuously.

55. The method of claim 39, wherein the processing zone comprises a container and a rotation arrangement, further wherein the rotation arrangement is arranged within the container and is rotatable relative to the container and the crystallization step and/or transformation step is performed between an inner wall of the container and the rotation arrangement.

56. The method of claim 55, wherein the container comprises an outer cylinder and the rotation arrangement comprises an inner cylinder.

57. The method of claim 56, wherein the shear stress in the crystallization step and/or transformation step is provided between the inner cylinder and the outer cylinder by rotating the inner cylinder relative to the outer cylinder.

58. The method of claim 56, wherein the inner cylinder is heated.

59. The method of claim 39, wherein an output of the processing zone may selectively be fed back to an input of the processing zone.

60. The method of claim 39, wherein the edible fat comprises StOSt-triglycerides in an amount of 40-99% by weight.

61. The method of claim 39, wherein the edible fat comprises shea fat.

62. The method of claim 39, wherein the seed suspension exhibits an endotherm melt peak position at about 40 degrees Celsius or higher.

63. The method of claim 39, further comprising:
mixing the seed suspension with a chocolate composition to obtain a seeded chocolate composition; and
tempering the chocolate composition before, during and/or after the step of mixing with the seed suspension.

64. A method for producing a heat stable chocolate, comprising:
performing a crystallization step on an edible fat in a processing zone to obtain a seed suspension by:
subjecting the edible fat to a cooling temperature below 30 degrees Celsius in the processing zone; and
subjecting the edible fat to shear stress in the processing zone;
mixing the seed suspension with a chocolate composition at a temperature above 30 degrees Celsius;
tempering the chocolate composition before, during and/or after the step of mixing with the seed suspension; and
cooling the seeded chocolate composition to obtain the heat stable chocolate;
wherein the edible fat comprises SatOSat-triglycerides in an amount of 20-99% by weight, wherein Sat denotes a saturated fatty acid and O denotes oleic acid; and
wherein the edible fat has a weight-ratio between that of
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,

65. The method of claim 64, wherein the seed suspension is produced by the method of claim 39.

66. A seed suspension comprising 20-99% by weight of SatOSat-triglycerides,
wherein the seed suspension has a weight-ratio between that of
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,
of between 0.40 and 0.99; and
wherein the seed suspension exhibits an endotherm melt peak position about 40 degrees Celsius or higher.

67. The seed suspension of claim 66, wherein the seed suspension is obtainable by the method of claim 39.

68. A confectionery product comprising a heat stable chocolate,
wherein the heat stable chocolate has a fat phase comprising
20-99% by weight of SatOSat-triglycerides; and
seed crystals;
wherein the seed crystals have a weight-ratio between that of
triglycerides having C18-C24 saturated fatty acids in the sn-1 and sn-3 positions and oleic acid in the sn-2 position of the triglyceride, and
triglycerides having C16-C24 saturated fatty acids in the sn-1 and sn-3 positions and oleic acid in the sn-2 position of the triglyceride,
of between 0.40 and 0.99, and
wherein the heat stable chocolate exhibits an endotherm melt peak position at about 35 degrees Celsius or higher.

69. The confectionery product of claim 68, wherein the seed crystals are added in the form of the seed suspension obtained by the method of claim 39.

70. A seed suspension apparatus for production of a seed suspension,
the seed suspension apparatus being adapted for receiving an edible fat,
the seed suspension apparatus comprising:
a processing zone adapted to subject a shear stress, a cooling temperature and a transformation temperature to the edible fat; and
a control circuit adapted to control the cooling temperature to be below 30 degrees Celsius and the transformation temperature to be equal to or above 15 degrees Celsius.

71. The seed suspension apparatus of claim 70, wherein the seed suspension apparatus is adapted to operate in accordance with the method of claim 39.

72. A seed suspension obtained by the method of claim 39 for seeding a chocolate or chocolate-like product.
